(19) United States
(12) Patent Application Publication
(10) Pub. No.: US 2026/0156012 A1
(43) Pub. Date: Jun. 4, 2026

(54) Broadcast, Unknown Unicast, and Link-Local Multicast Traffic Support Using Locator/Identifier Separation Protocol and Protocol Independent Multicast-Source-Specific Multicast

(71) Applicant: Cisco Technology, Inc., San Jose, CA (US)

(72) Inventor: Raphael Lienard, Luxembourg (LU)

(21) Appl. No.: 18/969,222

(22) Filed: Dec. 4, 2024

(51) Int. Cl. H04L 12/18; H04L 12/46; H04L 45/16

(52) U.S. Cl. CPC H04L 12/185; H04L 12/4633; H04L 45/16

(57) ABSTRACT

Systems, devices, and methods support network traffic, for example, Broadcast, unknown Unicast, and link-local Multicast (BUM) traffic, in an overlay by utilizing Protocol Independent Multicast (PIM)-Source-Specific Multicast (SSM) in an underlay, while removing dependency on PIM-Any Source Multicast (ASM). A mapping system receives a mapping registration message and/or a mapping request message of a candidate device configured with a virtual network instance, for example, a Layer 2 Virtual Network Instance (L2VNI) implemented with layer 2 flooding. In response to receiving the mapping registration message, the mapping system transmits a mapping notification message to one or more member devices of an underlay group associated with the L2VNI. The mapping notification message indicates that the candidate device has joined the underlay group. In response to receiving the mapping request message, the mapping system transmits, to the candidate device, a list indicating that the member device(s) intends to transmit the network traffic.

The present disclosure relates to networking. More particularly, the present disclosure relates to supporting network traffic, for example, Broadcast, unknown Unicast, and link-local Multicast (BUM) traffic, in an overlay network using Locator/Identifier Separation Protocol (LISP) and Protocol Independent Multicast (PIM) – Source-Specific Multicast (SSM).

### BACKGROUND

Software-Defined Networking (SDN) may provide an approach to networking that utilizes software-based controllers or application programming interfaces to communicate with underlying hardware infrastructure and direct traffic on a network. Many fabric networks may leverage SDN for centralized management, automation, and configuration of the network. For example, a software-defined fabric network may be utilized in the automation of wired and wireless campus networks. Such fabric networks may provide many optimizations to improve unicast traffic flow, and to reduce unnecessary flooding of data such as broadcasts. However, for some applications, it may be desirable to enable broadcast forwarding within the fabric networks, which may be disabled by default in a fabric network architecture. Large deployments of fabric networks may often require multiple fabric sites to be created for horizontal scaling and lower failure domains. However, some fabric networks may not provide a built-in feature for extending pure Layer 2 Virtual Network Instances (L2VNIs) with Broadcast, unknown Unicast, and link-local Multicast (BUM) traffic support across several fabric sites, and hence this extension may require the utilization of additional multicast routing protocols such as Protocol Independent Multicast (PIM)-Any Source Multicast (ASM) in a core network.

Further, some fabric networks may allow for an extension of Layer 2 and Layer 3 connectivity across an overlay network through a Locator/Identifier (ID) Separation Protocol (LISP). In LISP-enabled fabric networks, Ingress Tunnel Routers (ITRs) communicate with a LISP control plane to dynamically learn to which Egress Tunnel Router (ETR) unicast traffic should be encapsulated. However, for overlay BUM traffic, the conventional implementation of LISP may not provide a native capability to dynamically discover or learn the ingress/egress Tunnel Router (xTR) interested to transmit or receive the BUM traffic for a particular L2VNI, which may, therefore, be handed over to the PIM-ASM in an underlay. The inability to dynamically discover an ETR associated with an L2VNI by an ITR may not pose a problem when only one fabric site with a proper PIM-ASM is configured in the underlay. However, this inability may become problematic when L2VNIs need to be extended across multiple fabric sites.

In typical deployments, L2VNIs may be site-specific. To avoid unsolicited BUM traffic, local PIM Rendezvous Points (RPs) may be configured on each fabric site. However, there are scenarios where L2VNIs are required to be stretched across multiple fabric sites. In such scenarios, an additional central PIM RP may be created. In a dynamic environment, the underlay multicast configuration required to transport BUM traffic can become error-prone and complex to manage. For example, the configuration of a central PIM RP may not be automated during conventional automation processes and there may not be any workflow to reconfigure multicast in the underlay on an existing network. Moreover, as there are no dynamic PIM RP discovery mechanisms supported in conventional fabric networks, all devices need to be provisioned if any changes are required, which is a challenge when a network administrator needs to configure custom changes on a large number of devices. Furthermore, for fabric networks with external gateways, peer-to-peer BUM traffic may not always be desirable (for example, in cases of a guest network with endpoints that only need to transmit BUM traffic to a gateway), which may introduce stability, performance, and security concerns.

### SUMMARY OF THE DISCLOSURE

Systems, devices, and methods for supporting network traffic, for example, Broadcast, unknown Unicast, and link-local Multicast (BUM) traffic, in an overlay network by utilizing Protocol Independent Multicast (PIM)-Source-Specific Multicast (SSM) in an underlay network and Locator/Identifier Separation Protocol (LISP) in accordance with embodiments of the disclosure are described herein.

In many embodiments, a system comprises a processor, a network interface controller configured to provide access to a network, and a memory communicatively coupled to the processor. The memory comprises a communication management logic that is configured to receive at least one of a mapping registration message or a mapping request message of a candidate device configured with a virtual network instance. In response to receiving the mapping registration message, the communication management logic is further configured to transmit a mapping notification message to one or more member devices of an underlay group associated with the virtual network instance. The mapping notification message indicates that the candidate device has joined the underlay group. In response to receiving the mapping request message, the communication management logic is further configured to transmit, to the candidate device, a list indicating that the one or more member devices intend to transmit network traffic.

In a number of embodiments, the system further comprises a control plane database configured to update a list of routing locators with a routing locator of the candidate device that joined the underlay group.

In a variety of embodiments, the underlay group is a source-specific multicast transport group configured to receive and transmit the network traffic.

In several embodiments, the mapping registration message, the mapping request message, and the mapping notification message are control plane messages defined by a locator/identifier separation protocol.

In numerous embodiments, the mapping registration message comprises a routing locator of the candidate device and an indication of the underlay group mapped to the virtual network instance, indicating an intent of the candidate device to transmit the network traffic for the virtual network instance.

In further embodiments, the mapping request message comprises an indication of the underlay group mapped to the virtual network instance, indicating an intent of the candidate device to receive the network traffic for the virtual network instance.

In more embodiments, the candidate device is a tunnel router comprising a plurality of ports.

In various embodiments, one or more ports of the plurality of ports are configured with a virtual local area network mapped to the virtual network instance.

In numerous embodiments, the virtual network instance corresponds to a layer 2 virtual network instance implemented with layer 2 flooding.

In still more embodiments, the mapping notification message is configured to trigger transmission of a multicast join message from at least one member device of the one or more member devices to the candidate device.

In yet more embodiments, the communication management logic is further configured to receive another mapping registration message from the candidate device, the another mapping registration message indicating a removal of the candidate device from the underlay group to discontinue at least one of transmission or reception of the network traffic associated with the virtual network instance.

In still yet more embodiments, the network traffic comprises broadcast, unknown unicast, or link-local multicast traffic that is supported in an overlay network by utilizing protocol independent multicast-source-specific multicast in an underlay network.

In many further embodiments, a network device comprises a processor, a network interface controller configured to provide access to a network, and a memory communicatively coupled to the processor. The memory comprises a communication management logic that is configured to receive a configuration of a network mapped to a virtual network instance, transmit a mapping registration message indicating an intent to transmit network traffic for the virtual network instance, and receive, based on transmitting the mapping registration message, a set of multicast join messages from one or more member devices of an underlay group associated with the virtual network instance.

In many additional embodiments, the set of multicast join messages comprises at least one protocol independent multicast join message.

In numerous additional embodiments, the communication management logic is further configured to transmit another mapping registration message to a locator/identifier separation protocol control plane, indicating a removal of the network device from the underlay group, and receive, based on transmitting the another mapping registration message, a set of prune messages from the one or more member devices.

In several additional embodiments, a network device comprises a processor, a network interface controller configured to provide access to a network, and a memory communicatively coupled to the processor. The memory comprises a communication management logic that is configured to receive a configuration of a network mapped to a virtual network instance, transmit a mapping request message indicating an intent to receive network traffic for the virtual network instance, receive a list of one or more member devices of an underlay group associated with the virtual network instance, and transmit a multicast join message to the one or more member devices based on the received list.

In yet additional embodiments, the list is a full list of the one or more member devices that intend to transmit the network traffic.

In one or more embodiments, the multicast join message is transmitted to the one or more member devices in the underlay group in response to the list being a non-empty list.

In many more embodiments, the multicast join message is a protocol independent multicast-source-specific multicast message.

In further additional embodiments, the communication management logic is further configured to transmit at least one of a mapping registration message to a locator/identifier separation protocol control plane or a prune message to the one or more member devices, indicating a removal of the network device from the underlay group.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a block diagram of a network environment including a Locator/Identifier (ID) Separation Protocol (LISP)-enabled fabric network in accordance with various embodiments of the disclosure;

FIG. 2 is a block diagram of a system implementing a multi-site, LISP-enabled fabric network and executing register/join operations for devices associated with a virtual network instance in accordance with various embodiments of the disclosure;

FIG. 3 is a block diagram of a system implementing multi-site, LISP-enabled fabric network and executing support of Broadcast, unknown Unicast, and link-local Multicast (BUM) traffic, in an overlay network by utilizing Protocol Independent Multicast-Source-Specific Multicast in an underlay network in accordance with various embodiments of the disclosure;

FIG. 4 is a flowchart depicting a process for managing LISP control plane messages to support BUM traffic in an overlay network in accordance with various embodiments of the disclosure;

FIG. 5 is a flowchart depicting a process for dynamically discovering member devices of an underlay group that intend to transmit BUM traffic to a registered candidate device in accordance with various embodiments of the disclosure;

FIG. 6 is a flowchart depicting a process for managing mapping and removal operations with respect to a candidate device configured with a virtual network instance for BUM traffic in accordance with various embodiments of the disclosure;

FIG. 7 is a flowchart depicting a process for registering and deregistering a candidate device operating as an ingress tunnel router with/from an underlay group associated with a virtual network instance for network traffic in accordance with various embodiments of the disclosure;

FIG. 8 is a flowchart depicting a process for registering and deregistering a candidate device operating as an egress tunnel router with/from an underlay group associated with a virtual network instance for network traffic in accordance with various embodiments of the disclosure;

FIG. 9 is a flowchart depicting a process for registering and deregistering a candidate device operating as an ingress/egress tunnel router with/from an underlay group associated with a virtual network instance for network traffic in accordance with various embodiments of the disclosure; and

FIG. 10 is a conceptual block diagram for a device capable of executing components and a communication management logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems, devices, and methods are discussed herein for supporting network traffic, for example, Broadcast, unknown Unicast, and link-local Multicast (BUM) traffic, in an overlay network by utilizing Protocol Independent Multicast (PIM)-Source-Specific Multicast (SSM) in an underlay network and Locator/Identifier Separation Protocol (LISP), while improving configurations and removing dependency on PIM-Any Source Multicast (ASM). A broadcast may refer to a one-to-all transmission where a source may transmit one copy of a message to all nodes, whether they wish to receive the message or not. An unknown unicast may refer to a transmission from one specific source to one specific destination that a switch may not have in its forwarding table. For example, the unknown unicast may be transmitted when a destination Media Access Control (MAC) address is not known to the switch. A multicast may refer to a routing technique that allows Internet Protocol (IP) traffic to be transmitted from one source or multiple sources and delivered to multiple destinations. Instead of transmitting individual packets to each destination, a single packet may be transmitted to a group of destinations known as a multicast group, which may be identified by a single IP destination group address. Multicast addressing may support the transmission of a single IP datagram to multiple hosts. Link-local multicast may refer to a multicast communication that occurs within a single local network segment (also known as a link). Link-local multicast may be utilized for services that are confined to a local network. Link-local multicast addresses may be utilized for communication between devices that are on the same physical or logical link, that is, within the same subnet.

Further, PIM may refer to a multicast routing architecture that enables IP multicast routing on existing IP networks. PIM may be independent of any underlying unicast protocol such as an Open Shortest Path First (OSPF) protocol or a Border Gateway Protocol (BGP). PIM may be utilized to build a path backwards from a receiver to a source, effectively building a tree. This tree may have a root with branches leading out to interested candidates for given traffic. In the current state of the art of a fabric network, PIM-ASM in the underlay may be the only supported way for BUM traffic to be forwarded in the overlay. Fabric networks have evolved from conventional campus designs to networks that directly implement the intent of an organization. A fabric network architecture may be supported by fabric technology implemented for a campus, enabling the utilization of virtual networks, herein referred to as “overlay networks,” running on a physical network, herein referred to as an “underlay network,” creating alternative topologies to connect devices in the network. An overlay network may create a logical topology for virtually connecting devices that are built over an arbitrary physical underlay topology. The underlay network may be defined, for example, by physical switches and routers that may be utilized to deploy the fabric network. PIM-ASM may refer to a multicast routing protocol that is utilized to deliver multicast traffic to multiple receivers across the fabric network. ASM may allow any source to transmit multicast traffic to a multicast group, which may be utilized for applications where the source of the multicast traffic may change dynamically. Alternatively, PIM-SSM may refer to a multicast routing protocol that allows for distribution of multicast traffic from a specific source to specific receivers.

With PIM-ASM, the root of the tree may be a Rendezvous Point (RP). The RP may refer to a Layer 3 device, for example, a router, in a multicast network that acts as a shared root for a multicast distribution tree. PIM-ASM may rely on the RP to manage multicast group membership and routing. With PIM-SSM, the root of the multicast distribution tree is the source itself. In a multicast distribution tree, multicast traffic may flow from the source to the multicast group over a distribution tree that connects all the sources to all the receivers in the multicast group. This distribution tree may be a shared tree shared by all sources, or a source tree where a separate distribution tree can be built for each source. The shared tree may be unidirectional or bidirectional. In a PIM-ASM routing architecture, the multicast distribution tree is rooted at the RP. This multicast distribution tree may be referred to as an RP-Tree (RPT), as the RP may act as a meeting point for sources and receivers of multicast data. In a fabric network, RPs can be configured to cover different virtual networks. Active multicast sources may be registered with the RP, and network devices with interested multicast receivers may join the multicast distribution tree at the RP. In a shared tree model such as PIM-ASM, the path through the RP may not be the shortest path from the receiver back to the source. In a source tree model such as PIM-SSM, an optimal path may be created between the source and the receiver without the need to meet at the RP. In a network where multicast traffic is prevalent, if a switch does not have a specific multicast forwarding entry in its table, the switch may resort to flooding the multicast packets to all ports, similar to broadcast and unknown unicast behavior.

If broadcast, link-local multicast, and Address Resolution Protocol (ARP) flooding is required, it must be specifically enabled on a per-subnet basis using a Layer 2 flooding feature. Layer 2 flooding can be utilized to forward broadcasts for certain traffic and application types which may require leveraging of Layer 2 connectivity. Layer 2 flooding may operate by mapping an overlay subnet to a dedicated multicast group in the underlay. By default, the fabric network may transport frames without Layer 2 flooding of broadcast and unknown unicast traffic, and other methods may be utilized to address ARP requirements and ensure that standard IP communication may be transmitted from one endpoint to another. In a conventional implementation of the fabric network, Layer 2 flooding requires PIM-ASM in the underlay. When Layer 2 flooding is enabled for a given subnet, a multicast shared tree may be pre-built and rooted at the RP. For Layer 2 flooding to work, the RP must be in the underlay. This RP can be configured manually or programmatically through automation processes.

Large fabric network deployments often require multiple fabric sites to be created for horizontal scaling and lower failure domains. In many embodiments, the systems, devices, and methods discussed herein may allow for extending pure L2VNIs with BUM traffic support across several fabric sites. An L2VNI may refer to a specific overlay network segment including endpoint devices within the same IP subnet. Conventionally, to extend L2VNIs without an anycast gateway across multiple fabric sites, a central PIM RP may be configured in the underlay to allow network devices from selected fabric sites to register themselves as sources and clients of a selected underlay multicast group that may be utilized to transport the BUM traffic between the fabric sites in the overlay. The configuration of this central PIM RP may not be automated during conventional automation processes and there may not be any workflow to reconfigure multicast in the underlay on an existing network. In a conventional fabric network implementation, PIM-ASM in the underlay may be the only supported way for forwarding the BUM traffic in the overlay. PIM-ASM requires configuration of the PIM RP for discovering intent for transmitting and receiving the BUM traffic and facilitating transmission and reception of the BUM traffic between the network devices. As a network device may intend to directly connect with other network devices within and between multiple fabric sites, for transmitting and receiving the BUM traffic, the dependency of PIM-ASM, which utilizes the PIM RP, for site local and inter-sites Layer 2 flooding, needs to be removed.

In a number of embodiments, the systems, devices, and methods discussed herein may remove the dependency on PIM-ASM for local site and inter-sites layer 2 flooding. The systems, devices, and methods discussed herein may improve the way layer 2 flooding operates in a LISP-enabled fabric network. Unlike PIM-ASM, which allows multicast traffic from any source to a multicast group, PIM-SSM may be configured for scenarios where multicast traffic originates from a specific source, which enhances security and efficiency since receivers only receive traffic from known sources. Further, PIM-SSM may improve the multicast routing process by eliminating the need for the RP, which is required in PIM-ASM. Eliminating the need for the RP may reduce complexity and overhead in the multicast routing infrastructure. In a variety of embodiments, the systems, devices, and methods discussed herein may further provide flexibility to any fabric network customer that may have a requirement to provide layer 2 mobility across multiple fabric sites.

Further, in a Locator/Identifier (ID) Separation Protocol (LISP) Publisher (Pub)/Subscriber (Sub) model implemented by utilizing a control plane messaging protocol such as LISP, Ingress Tunner Routers (ITRs) may utilize a LISP control plane to dynamically learn to which Egress Tunnel Router (ETR) unicast traffic should be encapsulated. LISP may refer to a routing architecture in which an identifier of a device, referred to as its Endpoint Identifier (EID), and its location, identified by its Routing Locator (RLOC), are split into two different name spaces. LISP may also provide a dynamic mapping mechanism between the two address families. RLOCs may remain associated with a network topology and may be reachable via conventional routing; however, EIDs can change location dynamically and may be reachable via different RLOCs, depending on where an EID attaches to a network. The RLOC may be defined by a loopback address that is utilized as a tunnel source or destination.

In various embodiments, the LISP may be extended to dynamically learn which ingress/egress Tunnel Router (xTR), for example, which ITR or ETR, may be interested to transmit or receive BUM traffic for a particular L2VNI, for example, when a fabric border with the L2VNI is configured. The fabric border may provide a common control plane that can be shared across multiple xTRs from several different fabric sites to register endpoints in a stretch layer 2 network to allow inter-site Layer 2 communications. In several embodiments, the fabric border may also include a shared proxy-ETR aspect where all the xTRs in that stretch layer 2 network can send their traffic to where the destination is unknown. The intended LISP map server/map resolver feature extension may allow xTRs to register their intent to receive and transmit for a specific multicast group in the underlay. In some cases such as guest networks where peer-to-peer communications are not relevant, BUM traffic may only be required between an endpoint and its gateway (Address Resolution Protocol “ARP,” Dynamic Host Configuration Protocol “DHCP” discover). In this scenario, multicast distribution trees may only be formed between ITRs and a proxy ETR to save on resources, for example, bandwidth, Ternary Content-Addressable Memory (TCAM) entries, or the like. In more embodiments, the systems, devices, and methods discussed herein may completely remove PIM-ASM from the underlay in fabric networks, for example, in LISP Pub/Sub-based fabric networks, and rely on PIM-SSM and the LISP to support native multicast register/join operations for devices participating in a particular L2VNI and create multicast distribution trees.

Further, in additional embodiments, the systems, devices, and methods discussed herein may allow an xTR to query/register the map server/map resolver of a control plane node for native multicast transport groups to support overlay BUM traffic in a PIM-ASM free underlay network. In further embodiments, the systems, devices, and methods discussed herein may extend the LISP to support a feature similar to a PIM RP to allow an ETR participating in a specific L2VNI to be dynamically discovered by an ITR. In these embodiments, PIM-SSM can then be used to form the multicast distribution tree. In still more embodiments, PIM-SSM may provide a capability to an xTR to connect directly to another xTR that has multicast traffic. Moreover, in still further embodiments, the systems, devices, and methods discussed herein may leverage native multicast with PIM-SSM. Furthermore, in still additional embodiments, the LISP may include an actual discovery of the devices participating to the same layer 2 network.

In some more embodiments, the systems, devices, and methods discussed herein may implement a clean underlay network capable of supporting BUM traffic including layer 2 and layer 3 multicast, by utilizing only LISP and PIM-SSM, without any static configurations on network devices or usage of protocols such BGP, PIM-ASM, or a Multicast Source Discovery Protocol (MSDP). In yet various embodiments, multi-sites Layer 2 networks allowing BUM traffic and dynamic discovery of xTR members participating in an L2VNI may be built into the LISP-enabled fabric network. In yet more embodiments, an orchestration tool may merely need to configure the underlay with PIM sparse mode on routed links and PIM SSM as a default method without having to configure an anycast RP. PIM sparse mode may refer to a multicast routing protocol designed to optimally route multicast traffic to multiple receivers in a network. In still yet more embodiments, the systems, devices, and methods discussed herein may integrate a dynamic multicast source discovery mechanism directly into the LISP, which may provide full deployment flexibility without impacting the underlay. In many further embodiments, the systems, devices, and methods discussed herein may be utilized in use cases, for example, where a guest network subnet is owned by a third party company and a gateway must reside outside the fabric network, a layer 2 network with layer 2 multicast support may need to be extended from a data center to multiple campus sites, or the like.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user’s computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in many additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in numerous embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

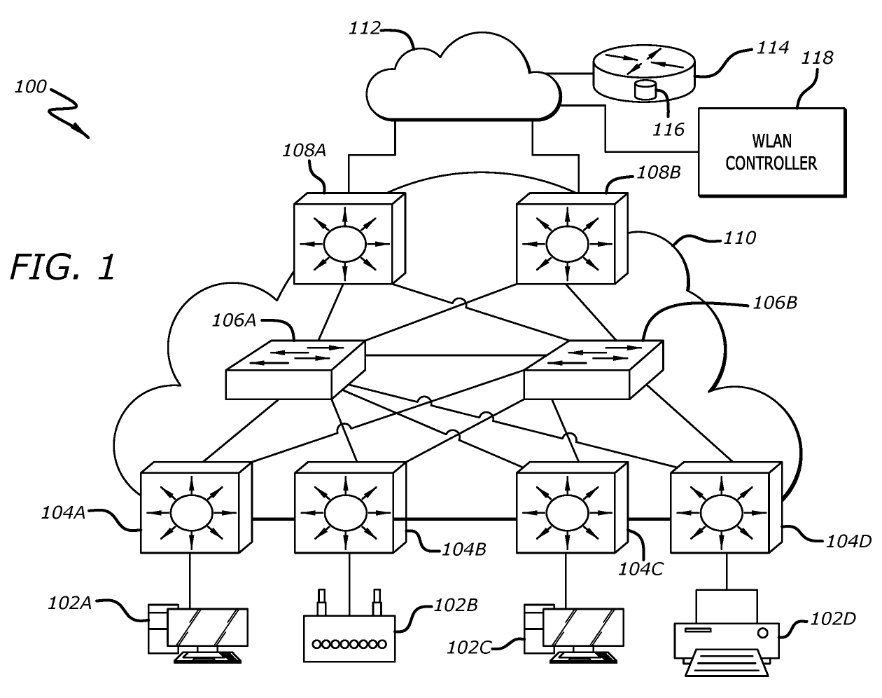

Referring to FIG. 1, a block diagram of a network environment 100 including a Locator/Identifier (ID) Separation Protocol (LISP)-enabled fabric network 110 in accordance with various embodiments of the disclosure is shown. In many embodiments, the LISP-enabled fabric network 110 may fully support Broadcast, unknown Unicast, and link-local Multicast (BUM) traffic in an overlay network using Protocol Independent Multicast (PIM)-Source-Specific Multicast (SSM) in an underlay network, while improving configurations and removing dependency on PIM-Any Source Multicast (ASM). The underlay network may constitute an underlying physical layer defined, for example, by physical switches and routers that are utilized to deploy the LISP-enabled fabric network 110. The underlay network may transport data packets between network devices in the overlay network. The overlay network may refer to a virtual and tunneled network that may interconnect the network devices virtually, forming a fabric network. The overlay network may implement policy-based network segmentation, host mobility in wired and wireless networks, and network security. The overlay network may also overcome complexities and constraints of the underlay network.

In a number of embodiments, the fabric network formed by the overlay network may include a fabric control plane based on the LISP. SSM may refer to a datagram delivery model that supports one-to-many applications, also known as broadcast applications. SSM may represent a core network technology for an implementation of Internet Protocol (IP) multicast targeted, for example, for audio and video broadcast application environments. For the SSM delivery mode, an IP multicast receiver host may use an Internet Group Management Protocol (IGMP) Version 3 (IGMPv3) to subscribe to a channel (S,G). By subscribing to this channel, the IP multicast receiver host may indicate that it wants to receive IP multicast traffic transmitted by a source host S to a group G. The LISP-enabled fabric network 110 may deliver IP multicast packets from the source host S to the group G to all hosts that have subscribed to the channel (S,G). SSM may not require group address allocation within the network, only within each source host.

In a variety of embodiments, the LISP-enabled fabric network 110 may include, for example, edge devices 104A, 104B, 104C, and 104D, intermediate devices 106A and 106B, and border devices 108A and 108B as illustrated in FIG. 1. The edge devices 104A – 104D may be equivalent to an access layer switch where traffic may enter the LISP-enabled fabric network 110 from endpoint devices 102A, 102B, 102C, and 102D or exit the LISP-enabled fabric network 110 towards the endpoint devices 102A – 102D. In various embodiments, the edge devices 104A – 104D may include Ingress Tunnel Routers (ITRs), Egress Tunnel Routers (ETRs), and/or ingress/egress Tunnel Routers (xTRs). An ITR may include, for example, a LISP site edge device that receives packets from site-facing interfaces, or internal hosts, encapsulates the packets, and forwards the packets to remote LISP sites. Alternatively, the ITR may natively forward the packets to non-LISP sites. An ETR may include, for example, a LISP site edge device that receives packets from core-facing interfaces, or a transport infrastructure, decapsulates the packets, and delivers the packets to local endpoint devices at the site. Further, an xTR may be capable of executing the functionalities of an ITR and an ETR.

Multiple endpoint devices, for example, a first server 102A, an access point 102B, a second server 102C, a printer 102D, or the like may be operably connected to the edge devices 104A, 104B, 104C, and 104D, respectively. The endpoint devices 102A – 102D may connect to the LISP-enabled fabric network 110 via the edge devices 104A – 104D. The edge devices 104A – 104D may be connected to the border devices 108A and 108B via the intermediate devices 106A and 106B. The intermediate devices 106A and 106B may route traffic inside the LISP-enabled fabric network 110. The border devices 108A and 108B may act as gateways between the LISP-enabled fabric network 110 and an external network 112, for example, the Internet. The border devices 108A and 108B may represent entry and exit points to the LISP-enabled fabric network 110. The border devices 108A and 108B may include, for example, proxy xTRs.

In more embodiments, the network environment 100 may further include a control plane node 114 and a Wireless Local Area Network (WLAN) controller 118. The border devices 108A and 108B may be connected to the control plane node 114 and the WLAN controller 118 via the external network 112. In additional embodiments, the control plane node 114 may register Endpoint Identifiers (EIDs) of all the endpoint devices 102A – 102D that are connected to the edge devices 104A – 104D. The EID may refer to an address utilized for numbering or identifying an endpoint device in the LISP-enabled fabric network 110. The EIDs may include, for example, Media Access Control (MAC) addresses, Internet Protocol version 4 (IPv4) addresses, IP version 6 (IPv6) addresses, or the like. In many networks, the IP address associated with an endpoint device may define both its identity and its location in the network. In these networks, the IP address may be utilized for both network layer identification, that is, who the endpoint device is on the network, and as a network layer locator, that is, where the endpoint device is in the network or to which device the endpoint device is connected. While the location of an endpoint device in the network may change, the identity of the endpoint device and what the endpoint device can access may not have to change. The LISP may allow the separation of the identity and the location through a mapping relationship of two namespaces, for example, the EID to its routing locator (RLOC). In further embodiments, the LISP may refer to an architecture to communicate and exchange the relationship between these two namespaces. This relationship may be referred to as an EID-to-RLOC mapping. This EID and RLOC combination may provide all the necessary information for traffic forwarding, even if an endpoint utilizes an unchanged IP address when appearing in a different network location associated or mapped behind different RLOCs.

In still more embodiments, the control plane node 114 may include a control plane database 116, a map server, and/or a map resolver. In still further embodiments, the control plane database 116 may store an association of the endpoint devices 102A – 102D with the edge devices 104A – 104D, while decoupling their EIDs from their locations, that is, their closest routers, in the LISP-enabled fabric network 110. In still additional embodiments, the edge devices 104A – 104D may register all the endpoint devices 102A – 102D towards the control plane database 116. In some more embodiments, the control plane database 116 may refer to a Host Tracking Database (HTDB), which is a central repository of EID to RLOC (EID-to-RLOC) mappings. In yet various embodiments, the HTDB may be equivalent to a LISP site, which may include what EIDs can be and have been registered. In yet more embodiments, the map server may receive and utilize endpoint registrations indicating the associated RLOCs to populate the control plane database 116. In still yet more embodiments, the map resolver may receive map requests which may be encapsulated by ITRs. In many further embodiments, the map resolver may respond to queries from fabric devices, for example, the edge devices 104A – 104D, requesting RLOC mapping information from the control plane database 116 in the form of EID-to-RLOC mappings, which may inform a requesting device to which edge device an endpoint device is connected and thus where to direct traffic. The edge devices 104A – 104D may query the control plane node 114 to determine the RLOC associated with the destination address, for example, from an EID-to-RLOC mapping, and utilize that RLOC information as the traffic destination. In case of a failure to resolve the destination RLOC, the traffic may be transmitted to a default border device 108A or 108B. The response received from the control plane node 114 may be stored in a LISP map-cache, which may be merged to a forwarding table and installed in hardware.

In many additional embodiments, the WLAN controller 118 may be configured to execute multiple different functions including, for example, registering MAC addresses of the endpoint devices 102A – 102D into the control plane database 116 during multicast register/join operations and supplying edge device RLOC-association updates to the control plane database 116 during roam events. In still yet further embodiments, the WLAN controller 118 may also receive and manage EID-to-RLOC mapping information from the map server of the control plane node 114. In still yet additional embodiments, the WLAN controller 118 can support fabric-enabled access points, for example, the access point 102B, attached to the LISP-enabled fabric network 110, handling conventional tasks associated with a WLAN controller as well as interactions with the fabric control plane for multicast registration/join operations. In one or more embodiments, the WLAN controller 118 may communicate the mapping of the MAC addresses of the endpoint devices 102A – 102D and the IP addresses of the access points to the control plane node 114. The control plane node 114 may then notify the mapping information to the edge devices 104A, 104B, 104C, and 104D.

In several embodiments, the LISP-enabled fabric network 110 may be configured to extend virtual network instances, for example, Layer 2 Virtual Network Instances (L2VNIs), with Broadcast, unknown Unicast, and link-local Multicast (BUM) traffic support across several fabric sites. In several more embodiments, the LISP-enabled fabric network 110 may implement the LISP to dynamically discover or learn the xTR interested to transmit and/or receive the BUM traffic for a particular L2VNI. In numerous embodiments, PIM-ASM may be completely removed from the underlay in the LISP-enabled fabric network 110, and PIM-SSM and the LISP may be relied on to support native multicast register/join operations for devices participating in a particular L2VNI. In numerous additional embodiments, the LISP-enabled fabric network 110 may allow an xTR to query/register the map server and/or the map resolver of the control plane node 114 for native multicast transport groups to support overlay BUM traffic in a PIM-ASM free underlay network. In further additional embodiments, the systems, devices, and methods discussed herein may extend the LISP to support a feature similar to a PIM Rendezvous Point (RP) to allow ETRs participating in a specific L2VNI to be dynamically discovered by an ITR. In these embodiments, PIM-SSM can then be utilized to create multicast distribution trees. Further, the LISP-enabled fabric network 110 may remove the dependency on PIM-ASM for local site and inter-sites layer 2 flooding.

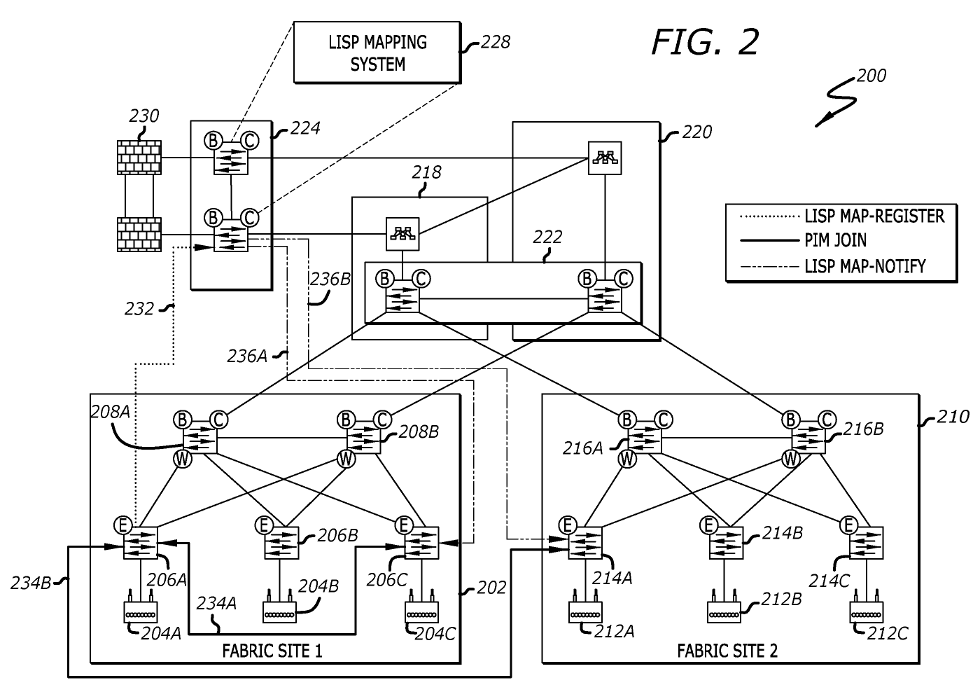

Although a specific embodiment for a network environment 100 including a LISP-enabled fabric network 110 suitable for carrying out the various steps, processes, methods, and operations described herein is discussed with respect to FIG. 1, any of a variety of systems and/or processes may be utilized in accordance with embodiments of the disclosure. For example, although FIG. 1 may illustrate a three-tiered campus design, the LISP-enabled fabric network 110 may be extended to include two, four, or more tiers in the campus design with BUM traffic support that utilizes PIM-SSM in the underlay. The elements depicted in FIG. 1 may also be interchangeable with other elements of FIGS. 2-10 as required to realize a particularly desired embodiment.

Referring to FIG. 2, a block diagram of a system 200 implementing a multi-site, LISP-enabled fabric network and executing register/join operations for devices associated with a virtual network instance in accordance with various embodiments of the disclosure is shown. In a conventional fabric network implementation, layer 2 flooding may require PIM-ASM in the underlay. Large fabric network deployments may require multiple fabric sites to be created for horizontal scaling and lower failure domains. A proper underlay design may require an anycast RP per fabric site when L2VNIs local to the fabric site with layer 2 flooding enabled are needed. The anycast RP may allow two or more RPs to share the load for source registration and act as backup routers for each other. In some cases, a common L2VNI may be required over multiple fabric sites, which may be supported by utilizing a fabric border that provides a shared control plane and proxy xTR features.

To support L2VNIs for multiple fabric sites without anycast gateways, a common anycast RP should be configured in the underlay to transport BUM traffic between fabric sites, which may not be automated by an automation process and which may not include a workflow to reconfigure multicast such as ASM in the underlay on an existing network. The automation process may be implemented to configure edge devices, for example, xTRs. The automation process may slow down the deployment process, because the RP may be configured on an initial network device. If the automation process is launched from a central site, for example, a datacenter site, towards a new remote site, the process needs to be stopped at the remote site borders and a new process needs to be started to make them become an anycast RP for the new remote site.

When a pure L2VNI is configured across multiple fabric sites, the BUM traffic may not be transported by default because the edge devices are not able to PIM join a central RP. To address this, conventionally, a multicast group access control list may be configured on the RP and a RP local to the fabric site is configured for all groups except the one belonging to the common L2VNI. This method is not intent-based and may be error-prone because multicast groups may change over time. There is a need for automating the configuration of storm control in such a case to avoid any issues in large layer 2 networks. Storm control may prevent traffic on a LAN from being disrupted by a BUM traffic storm on a port. The BUM traffic storm may occur when BUM packets flood the LAN, creating excessive traffic and degrading network performance. The configuration of storm control may prevent LAN ports from being disrupted by a BUM traffic storm on physical interfaces.

In many embodiments, the system 200 may be configured to fully support BUM traffic in the overlay using SSM in the underlay, thereby simplifying configurations and removing the dependency on PIM-ASM. The system 200 may preclude the need for manually configuring the ASM in the underlay if it was not performed during the automation process that onboards fabric devices. Moreover, the system 200 may preclude the need for manually configuring a central RP in the underlay for common L2VNIs over multiple fabric sites. Furthermore, depending on the use case, the system 200 may allow BUM traffic to be transmitted to all hosts in an L2VNI (full mesh) or steered towards a specific exit point (hub and spoke) if a gateway of endpoint devices is outside of the fabric and BUM traffic between internal endpoint devices is not required.

Consider an example where a virtual network instance, for example, an L2VNI, with BUM traffic support may be extended across two fabric sites, a fabric site 1 202 and a fabric site 2 210, as illustrated in FIG. 2. The fabric site 1 202 and the fabric site 2 210 may be collectively referred to as “fabric sites 202 and 210”. In a number of embodiments, the fabric sites 202 and 210 may be LISP-enabled sites. The system 200 may provide layer 2 mobility across the two fabric sites 202 and 210. The fabric site 1 202 may include edge devices 206A, 206B, and 206C operably coupled to border devices 208A and 208B and endpoint devices 204A, 204B, and 204C. Similarly, the fabric site 2 210 may include edge devices 214A, 214B, and 214C operably coupled to border devices 216A and 2 16B and endpoint devices 212A, 212B, and 212C. The edge devices 206A – 206C and 214A – 214C may include, for example, ITRs, ETRs, and/or xTRs. The endpoint devices 204A – 204C and 212A – 212C may include, for example, access points.

In addition to the fabric sites 202 and 210, the system 200 may include a control plane node 224 connected to one or more firewalls 230, and data centers DC1 218 and DC 2 220. The data centers DC1 218 and DC 2 220 may be connected by a datacenter fabric site 222. The control plane node 224 may include a LISP mapping system 228 configured to leverage the LISP to support native multicast register/join operations for devices participating in a particular L2VNI. The LISP mapping system 228 may include a map server, a map resolver, and a control plane database. In a variety of embodiments, the map server and the map resolver may store and restore EID-to-RLOC mapping information for the xTRs to route BUM traffic between the fabric sites 202 and 210. The map server may refer to a LISP infrastructure device with which the ETR functionality of each of the fabric sites 202 and 210 may register its EID prefix(s). In various embodiments, the map server may store the registered EID prefixes in the control plane database with each EID prefix mapped to an associated RLOC. In more embodiments, the fabric sites 202 and 210 may utilize the map server to resolve EID-to-RLOC mappings. The map resolver may refer to a LISP infrastructure device to which ITR functionality of each of the fabric sites 202 and 210 may transmit LISP Map Request queries when resolving EID-to-RLOC mappings. Upon receipt of a LISP Map Request query, the map resolver may determine the appropriate EID-to-RLOC mapping by checking with the map server, which may be co-located or distributed.

In additional embodiments, the system 200 may add a table to the control plane database to allow the fabric devices, for example, edge devices 206A – 206C in the fabric site 1 202, to register their intent to receive BUM traffic from a specific multicast group in the underlay. In further embodiments, a network administrator may implement an automation process to configure the underlay with PIM sparse mode on routed links and PIM SSM as a default method without having to configure an anycast RP. In still more embodiments, the control plane node 224 may include a fabric border configured to support a common L2VNI over the fabric sites 202 and 210.

Consider an example where the edge device 206A, operating as an ITR, wants to join an underlay group, for example, an SSM transport group, mapped to an L2VNI for BUM traffic and indicate intent to transmit BUM traffic for the particular L2VNI. On each edge device, the L2VNI-to-underlay group mapping is configured either statically or dynamically. This configuration informs the edge device which underlay group is associated with each L2VNI. For example, in a VxLAN configuration of the edge device, there may be an explicit mapping of an L2VNI for a particular Virtual Local Area Network (VLAN) to a specific multicast group address. This configuration may appear, for example, as: vxlan l2vni 5000; multicast-group 239.1.1.1. When a port of the edge device 206A is configured with a local VLAN that is mapped to an L2VNI with layer 2 flooding enabled, in some more embodiments, the edge device 206A may first transmit a mapping registration message, for example, a LISP MAP Register message 232, with its RLOC and the SSM transport group that is mapped to the L2VNI for BUM traffic, to the LISP mapping system 228 in the control plane node 224. The LISP MAP Register message 232 may indicate to the map server/map resolver of the LISP mapping system 228 that this edge device 206A intends to transmit BUM traffic for this particular L2VNI. In response to receiving the LISP MAP Register message 232, in yet various embodiments, the map server/map resolver may update a list of RLOCs with the RLOC of the edge device 206A that joined the SSM transport group, and proceed to perform a lookup in the control plane database to determine existing xTRs participating in this L2VNI. If records of existing xTRs are found in the control plane database, the map server/map resolver may transmit mapping notification messages to those xTRs to indicate that a new member has joined the L2VNI. For example, if the lookup displays records of an xTR 206C and an xTR 214A in the fabric site 1 202 and the fabric site 2 210, respectively, the map server/map resolver may transmit LISP MAP Notify messages 236A and 236B to the xTRs 206C and 214A, respectively, to indicate that a new member, that is, the edge device 206A, has joined the L2VNI. After receiving the LISP MAP Notify messages 236A and 236B, the xTRs 206C and 214A may transmit (S,G) PIM join messages 234A and 234B towards the new member, that is, the edge device 206A, where “S” may denote a source host, namely, the edge device 206A, and “G” may denote the SSM transport group. The system 200, therefore, leverages the LISP to support native multicast register/join operations for edge devices 206A, 206B, and 206C participating in a particular L2VNI.

In several embodiments, if the edge device 206A does not want to transmit the BUM traffic for this L2VNI, the edge device 206A may transmit a notification to the LISP mapping system 228 to remove the edge device 206A from the list. The edge device 206A may further send a PIM prune message to RLOCs associated with the xTRs 206C and 214A. In still additional embodiments, the system 200 may implement an automated storm control configuration on access ports.

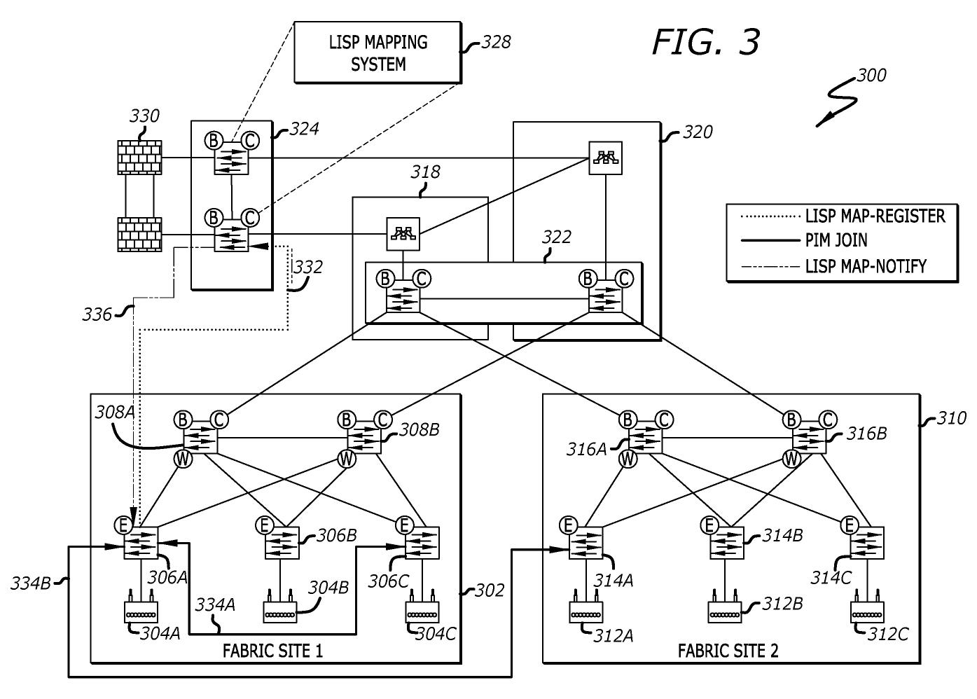

In further embodiments, the edge device 206A can additionally or alternatively operate as an ETR, with an intent to receive BUM traffic for the particular L2VNI. Various operations performed by an edge device to indicate an intent to receive BUM traffic for the particular L2VNI are described later in conjunction with FIG. 3. In embodiments where the edge device 206A intends to both transmit and receive BUM traffic for the particular L2VNI, the edge device 206A may be referred to as an xTR. In such a scenario, the edge device 206A after registering itself with the LISP mapping system 228 of the control plane node 224, via the mapping registration message, as a new multicast client of the SSM transport group, the edge device 206A may further query the LISP mapping system 228, via a mapping request message, for the list of all xTRs participating in the same L2VNI and transmit a PIM join message to the listed xTRs, for example, the xTRs 206C and 214A.

Although a specific embodiment for a system 200 implementing a multi-site, LISP-enabled fabric network and executing register/join operations for devices associated with a virtual network instance suitable for carrying out the various steps, processes, methods, and operations described herein is discussed with respect to FIG. 2, any of a variety of systems and/or processes may be utilized in accordance with embodiments of the disclosure. For example, if the VLAN is configured to steer the BUM traffic towards the fabric border in the control plane node 224, the edge device 206A may transmit a PIM join message to the fabric border and vice versa. The elements depicted in FIG. 2 may also be interchangeable with other elements of FIG. 1 and FIGS. 3 – 10 as required to realize a particularly desired embodiment.

Referring to FIG. 3, a block diagram of a system 300 implementing a multi-site, LISP-enabled fabric network and executing support of BUM traffic, in an overlay network by utilizing PIM-SSM in an underlay network in accordance with various embodiments of the disclosure is shown. In many embodiments, the system 300 may be configured to fully support BUM traffic in the overlay using SSM in the underlay, thereby simplifying configurations and removing the dependency on PIM-ASM. The system 300 may preclude the need for manually configuring the ASM in the underlay if it was not performed during an automation process. Moreover, the system 300 may preclude the need for manually configuring a central RP in the underlay for common L2VNIs over multiple fabric sites. Furthermore, depending on the use case, the system 300 may allow BUM traffic to be transmitted to all hosts in an L2VNI (full mesh) or steered towards a specific exit point (hub and spoke) if a gateway of endpoint devices is outside of the fabric and BUM traffic between internal endpoint devices is not required.

Consider an example where a virtual network instance, for example, an L2VNI, with BUM traffic support may be extended across two fabric sites, a fabric site 1 302 and a fabric site 2 310, as illustrated in FIG. 3. The fabric site 1 302 and the fabric site 2 310 may be collectively referred to as “fabric sites 302 and 310”. In a number of embodiments, the fabric sites 302 and 310 may be LISP-enabled sites. The system 300 may provide layer 2 mobility across the two fabric sites 302 and 310. The fabric site 1 302 may include edge devices 306A, 306B, and 306C operably coupled to border devices 308A and 308B and endpoint devices 304A, 304B, and 304C. Similarly, the fabric site 2 310 may include edge devices 314A, 314B, and 314C operably coupled to border devices 316A and 316B and endpoint devices 312A, 312B, and 312C. The edge devices 306A – 306C and 314A – 314C may include, for example, ITRs, ETRs, and/or xTRs. The endpoint devices 304A – 304C and 312A – 312C may include, for example, access points.

In addition to the fabric sites 302 and 310, the system 300 may include a control plane node 324 connected to one or more firewalls 330, and data centers DC1 318 and DC2 320. The data centers DC1 318 and DC2 320 may be connected by a datacenter fabric site 322. The control plane node 324 may include a LISP mapping system 328 configured to leverage the LISP to support native multicast register/join operations for devices participating in a particular L2VNI. The LISP mapping system 328 may include a map server, a map resolver, and a control plane database. In a variety of embodiments, the map server and the map resolver may store and restore EID-to-RLOC mapping information for the xTRs to route BUM traffic between the fabric sites 302 and 310. The map server may refer to a LISP infrastructure device with which the ETR functionality of each of the fabric sites 302 and 310 may register its EID prefix(s). In various embodiments, the map server may store the registered EID prefixes in the control plane database with each EID prefix mapped to an associated RLOC. In more embodiments, the fabric sites 302 and 310 may utilize the map server to resolve EID-to-RLOC mappings. The map resolver may refer to a LISP infrastructure device to which ITR functionality of each of the fabric sites 302 and 310 may transmit LISP Map Request queries when resolving EID-to-RLOC mappings. Upon receipt of a LISP Map Request query, the map resolver may determine the appropriate EID-to-RLOC mapping by checking with the map server, which may be co-located or distributed.

In additional embodiments, the system 300 may add a table to the control plane database to allow fabric devices, for example, edge devices 306A – 306C in the fabric site 1302, to register their intent to receive BUM traffic from a specific multicast group in the underlay. In further embodiments, a network administrator may implement an automation process to configure the underlay with PIM sparse mode on routed links and PIM SSM as a default method without having to configure an anycast RP. In still more embodiments, the control plane node 324 may include a fabric border configured to support a common L2VNI over the fabric sites 302 and 310.

Consider an example where an edge device 306A, operating as an xTR, wants to join an underlay group, for example, an SSM transport group, mapped to an L2VNI for BUM traffic and indicate intent to transmit and receive BUM traffic for the particular L2VNI. When a port of the edge device 306A is configured with a local VLAN that is mapped to an L2VNI with layer 2 flooding enabled, in still further embodiments, the edge device 306A may transmit a mapping registration message, for example, a LISP MAP Register message, with its RLOC and the SSM transport group that is mapped to the L2VNI for BUM traffic, to the LISP mapping system 328 in the control plane node 324. The LISP MAP Register message may indicate to the map server/map resolver of the LISP mapping system 328 that this edge device 306A intends to transmit BUM traffic for this particular L2VNI. In response to receiving the LISP MAP Register message, in still additional embodiments, the map server/map resolver may update a list of RLOCs with the RLOC of the edge device 306A that joined the SSM transport group, and proceed to perform a lookup in the control plane database to determine existing xTRs participating in this L2VNI. If records of existing xTRs are found in the control plane database, the map server/map resolver may transmit mapping notification messages to those xTRs to indicate that a new member has joined the L2VNI. For example, if the lookup displays records of an xTR 306C and an xTR 314A in the fabric site 1302 and the fabric site 2310, respectively, the map server/map resolver may transmit LISP MAP Notify messages to the xTRs 306C and 314A, respectively, to indicate that a new member, that is, the edge device 306A, has joined the L2VNI. After receiving the LISP MAP Notify messages, the xTRs 306C and 314A may transmit (S,G) PIM join messages towards the new member, that is, the xTR 306A, where “S” may denote a source host, namely, the xTR 306A, and “G” may denote the SSM transport group.

Further, to indicate the intent to receive BUM traffic for the particular L2VNI, the edge device 306A may transmit a mapping request message, for example, a LISP MAP Request message 332, for the SSM transport group that has been mapped to the L2VNI. The LISP MAP Request message 332 may request the map server/map resolver for a list of xTRs participating in the same L2VNI. The LISP MAP Request message 332 may indicate intent of the edge device 306A to receive the BUM traffic for this particular L2VNI. In some more embodiments, the map server/map resolver may respond with a list 336 including, for example, an empty list, or a list of border devices/remote border devices (if traffic steering is enabled), or a full list of xTRs if all the xTRs need to receive the BUM traffic. If the list of xTRs is not empty, the edge device 306A may transmit PIM-SSM join messages to the xTRs associated with the RLOC records. For example, if the map server/map resolver responds with a non-empty list including an xTR 306C and an xTR 314A from the fabric sites 302 and 310, respectively, the edge device 306A may transmit PIM-SSM join messages 334A and 334B to the xTRs 306C and 314A, respectively, associated with the RLOC records.

In one or more embodiments, if the edge device 306A no longer wants to receive and/or transmit BUM traffic for this L2VNI, the edge device 306A may transmit a mapping registration message to the map server/map resolver to remove itself from the list of xTRs participating in the L2VNI. For example, if the edge device 306A no longer wants to receive and/or transmit BUM traffic for this L2VNI, the edge device 306A may transmit a LISP MAP Register message with a Time-To-Live (TTL) value set to zero (0) for its RLOC, to the map server/map resolver to remove itself from the list of xTRs participating in the L2VNI. The map server/map resolver may remove the edge device 306A from the control plane database and transmit a mapping notification message, for example, a LISP MAP Notify message, to all the remote xTRs participating in the L2VNI. The edge device 306A may further transmit a PIM prune message to all the remote xTRs participating in the L2VNI. The remote xTRs that received the mapping notification message from the map server/map resolver may also transmit a PIM prune message to the edge device 306A leaving the SSM transport group. The system 300, therefore, leverages the LISP to support BUM traffic reception and multicast deregistration operations for edge devices 306A, 306B, and 306C participating in a particular L2VNI.

In an example scenario where the edge device 306A only intends to receive the BUM traffic for the particular L2VNI and does not intend to transmit BUM traffic, the edge device 306A may not transmit the mapping registration message and may directly transmit the mapping request message to the map server/map resolver. The mapping request message may include the RLOC of the edge device 306A and the SSM transport group that is mapped to the L2VNI.

Although a specific embodiment for a system 300 implementing a multi-site, LISP-enabled fabric network and executing support of BUM traffic, in an overlay network by utilizing PIM-SSM in an underlay network suitable for carrying out the various steps, processes, methods, and operations described herein is discussed with respect to FIG. 3, any of a variety of systems and/or processes may be utilized in accordance with embodiments of the disclosure. For example, the system 300 may allow creation of hub-and-spoke or full-mesh multicast distribution trees depending on use cases. The hub-and-spoke multicast distribution tree may refer to a multicast distribution tree where a central node or hub may transmit multicast traffic to peripheral nodes referred to as spokes. The full-mesh multicast distribution tree may refer to a multicast distribution tree where every node in a network may be directly connected to every other node in the network. The elements depicted in FIG. 3 may also be interchangeable with other elements of FIGS. 1-2 and FIGS. 4-10 as required to realize a particularly desired embodiment.

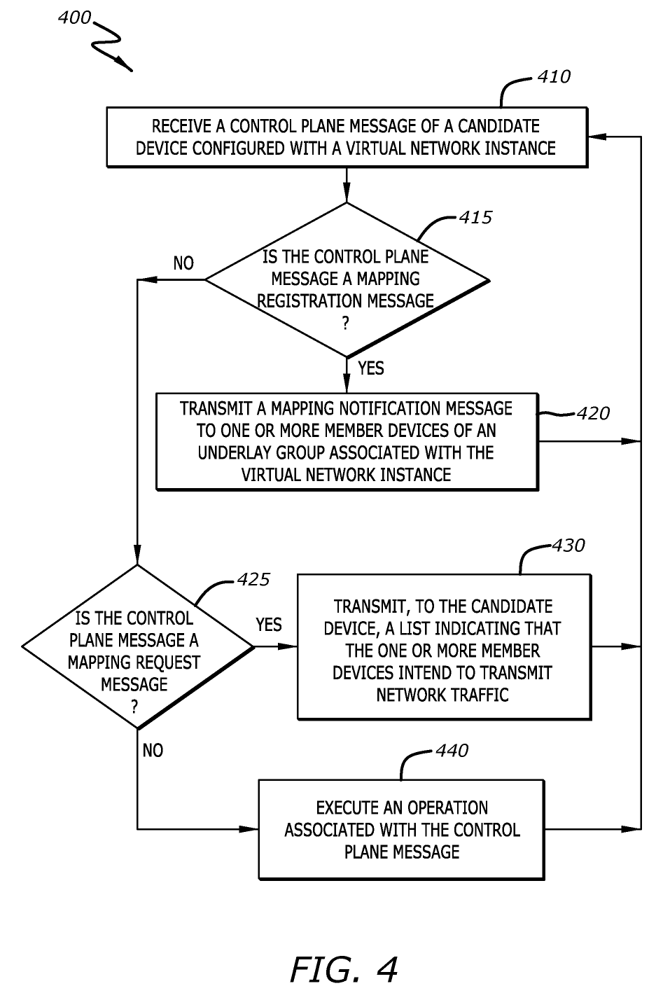

Referring to FIG. 4, a flowchart depicting a process 400 for managing LISP control plane messages to support BUM traffic in an overlay network in accordance with various embodiments of the disclosure is shown. In many embodiments, the process 400 may receive a control plane message of a candidate device configured with a virtual network instance (block 410). In a number of embodiments, the control plane message may be defined by the LISP. The control plane message may refer to a User Datagram Protocol (UDP) message with either a source or destination UDP port of 4342. The format of the control plane message may, for example, be an IPv4 or IPv6 format. The process 400 may receive the control plane message from the candidate device configured with the virtual network instance. The candidate device may refer to an edge device, for example, a tunnel router such as an ITR, an ETR, or an xTR. The candidate device may be a tunnel router including multiple ports. In a variety of embodiments, one or more of the ports of the candidate device may be configured with a local VLAN that is mapped to the virtual network instance. In various embodiments, the virtual network instance may correspond to an L2VNI implemented with layer 2 flooding. In more embodiments, the process 400 may receive the control plane message from the candidate device at a control plane node, which may include the map server/map resolver and the control plane database.

In additional embodiments, the process 400 may determine whether the control plane message is a mapping registration message (block 415). The mapping registration message may, for example, be a LISP MAP Register message. The mapping registration message may include an RLOC of the candidate device and an indication of an underlay group mapped to the virtual network instance for network traffic, for example, BUM traffic. The process 400 may support the BUM traffic in an overlay network by utilizing PIM-SSM in an underlay network. In further embodiments, the underlay group may be an SSM transport group configured to receive and transmit the network traffic. In still more embodiments, the mapping registration message may indicate an intent of the candidate device to transmit the network traffic for the virtual network instance.

In response to determining that the control plane message is a mapping registration message, in still further embodiments, the process 400 may transmit a mapping notification message to one or more member devices of an underlay group associated with the virtual network instance (block 420). The mapping notification message may, for example, be a LISP MAP Notify message. The member devices may refer to edge devices, for example, tunnel routers such as ETRs or xTRs. In still additional embodiments, the process 400 may transmit the mapping notification message from the control plane node to one or more member devices of the underlay group associated with the virtual network instance. The mapping notification message may notify the member device(s) of the underlay group that the candidate device has joined the virtual network instance. In some more embodiments, the mapping notification message may be configured to trigger transmission of a multicast join message from at least one member device to the candidate device. The multicast join message may, for example, be a PIM join message. In yet various embodiments, the process 400 may then proceed to receive another control plane message of a candidate device configured with the virtual network instance (block 410). The control plane message may, for example, be a mapping registration message or a mapping request message.

However, in response to determining that the control plane message is not a mapping registration message, in yet more embodiments, the process 400 may determine whether the control plane message is a mapping request message (block 425). The mapping request message may, for example, be a LISP MAP Request message. The mapping request message may request for a list of edge devices, for example, xTRs, participating in the same virtual network instance. In still yet more embodiments, the mapping request message may include an indication of the underlay group mapped to the virtual network instance, indicating an intent of the candidate device to receive the network traffic for the virtual network instance. In one or more embodiments, the mapping request message may include the RLOC of the candidate device and the indication of the underlay group mapped to the virtual network instance for the network traffic.

In response to determining that the control plane message is a mapping request message, in many further embodiments, the process 400 may transmit, to the candidate device, a list indicating that the one or more member devices intend to transmit the network traffic (block 430). In an example, the list may include an empty list. In another example, the list may include a list of border devices/remote border devices, if traffic steering is enabled. In a further example, the list may include a full list of member devices such as xTRs if all the member devices need to receive the network traffic. In many additional embodiments, the process 400 may transmit the list from the control plane node to the candidate device. In still yet further embodiments, the process 400 may then proceed to receive another control plane message of a candidate device configured with the virtual network instance (block 410).

However, in response to determining that the control plane message is not a mapping request message, in still yet additional embodiments, the process 400 may execute an operation associated with the control plane message (block 440). The control plane message may be a message other than the mapping registration message or the mapping request message. For example, the control plane message may be a LISP encapsulated control message. The LISP encapsulated control message may indicate operations to be performed in the LISP architecture. The operations may include control functions, for example, allowing the candidate device to register its current location with the control plane node, informing the LISP mapping system in the control plane node that the candidate device has moved, or the like. In several embodiments, the LISP encapsulated control message may be encapsulated within a LISP header. In several more embodiments, the process 400 may then proceed to receive another control plane message of a candidate device configured with the virtual network instance (block 410).

Although a specific embodiment for a process 400 for managing LISP control plane messages to support BUM traffic in an overlay network suitable for carrying out the various steps, processes, methods, and operations described herein is discussed with respect to FIG. 4, any of a variety of systems and/or processes may be utilized in accordance with various embodiments of the disclosure. For example, the process 400 may allow BUM traffic steering towards a specific exit point in the LISP-enabled fabric network. The elements depicted in FIG. 4 may also be interchangeable with other elements of FIGS. 1-3 and FIGS. 5-10 as required to realize a particularly desired embodiment.

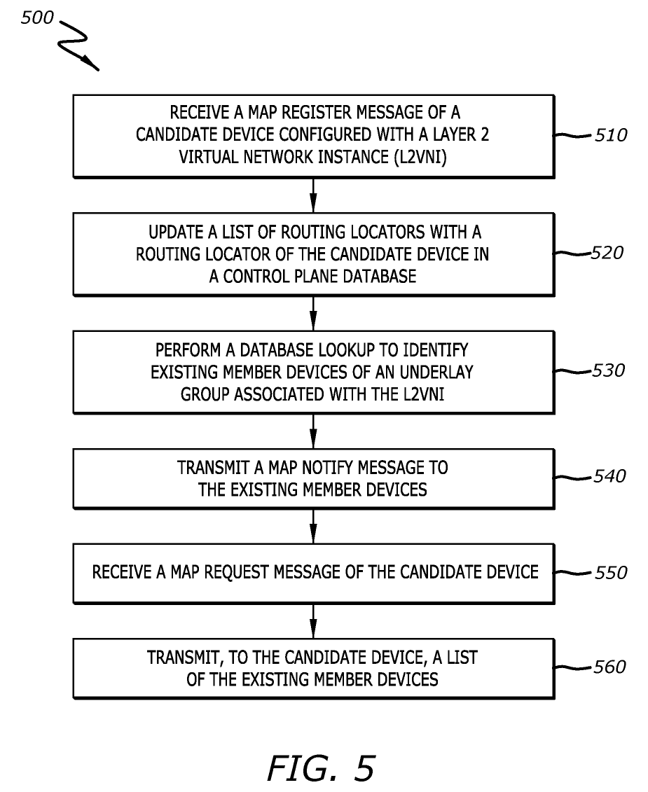

Referring to FIG. 5, a flowchart depicting a process 500 for dynamically discovering member devices of an underlay group that intend to transmit BUM traffic to a registered candidate device in accordance with various embodiments of the disclosure is shown. In many embodiments, the process 500 may receive a MAP Register message of a candidate device configured with an L2VNI (block 510). The MAP Register message (e.g., a mapping registration message) may refer to a control plane message defined by the LISP. The MAP Register message may include an RLOC of the candidate device and an indication of an underlay group mapped to the L2VNI for the BUM traffic. The process 500 may support the BUM traffic in an overlay network by utilizing PIM-SSM in an underlay network. In a number of embodiments, the underlay group may be an SSM transport group configured to receive and transmit the BUM traffic. In a variety of embodiments, the MAP Register message may indicate an intent of the candidate device to transmit the BUM traffic for the L2VNI.

The process 500 may receive the MAP Register message from the candidate device configured with the L2VNI. The candidate device may refer to an edge device, for example, a tunnel router such as an ITR, an ETR, or an xTR. The candidate device may be a tunnel router including multiple ports. In various embodiments, one or more of the ports of the candidate device may be configured with a local VLAN that is mapped to the L2VNI. In more embodiments, the L2VNI may be implemented with layer 2 flooding. In additional embodiments, the process 500 may receive the MAP Register message from the candidate device at a control plane node, which may include the map server/map resolver and the control plane database. The control plane database may store the RLOCs of all the edge devices in a LISP-enabled fabric network.

In further embodiments, the process 500 may update a list of RLOCs with an RLOC of the candidate device in the control plane database (block 520). The list of RLOCs may be associated with all the edge devices in the LISP-enabled fabric network. The process 500 may extract the RLOC of the candidate device that joined the underlay group from the MAP Register message and store the extracted RLOC in the control plane database. In still more embodiments, the control plane database may store an association of endpoint devices with the edge devices, while decoupling their EIDs from their locations, that is, their closest routers, in the LISP-enabled fabric network. In still further embodiments, the control plane database may refer to a Host Tracking Database (HTDB), which is a central repository of EID to RLOC (EID-to-RLOC) mappings. In still additional embodiments, the HTDB may be equivalent to a LISP site, which may include what EIDs can be and have been registered. In some more embodiments, the map server may receive and utilize endpoint registrations indicating the associated RLOCs to populate the control plane database.

In yet various embodiments, the process 500 may perform a database lookup to identify existing member devices of the underlay group associated with the L2VNI (block 530). That is, the process 500 may perform a lookup in the control plane database to identify existing member devices of the underlay group associated with the L2VNI. The member devices may refer to edge devices, for example, tunnel routers such as ETRs or xTRs. In yet more embodiments, the control plane database may store a mapping of an identifier of the L2VNI to the member devices participating in the L2VNI. In still yet more embodiments, the member devices may be identified by their MAC addresses or IP addresses. A lookup request may include the specific L2VNI for which the control plane node wants to retrieve member information. The control plane node may look up the control plane database for entries corresponding to the L2VNI.

In many further embodiments, the process 500 may transmit a MAP Notify message to the existing member devices (block 540). The MAP Notify message (e.g., a mapping notification message) may refer to a control plane message defined by the LISP. In many additional embodiments, the process 500 may transmit the MAP Notify message from the control plane node to the existing member devices of the underlay group associated with the L2VNI. The MAP Notify message may notify the existing member devices of the underlay group that the candidate device has joined the L2VNI. In still yet further embodiments, if the L2VNI is configured with traffic steering, only records with a proxy ETR flag may be configured to receive the MAP Notify message. In still yet additional embodiments, the MAP Notify message may be configured to trigger transmission of a multicast join message from at least one member device of the existing member devices to the candidate device. The multicast join message may, for example, be a PIM join message.

In several embodiments, the process 500 may receive a MAP Request message of the candidate device (block 550). The MAP Request message (e.g., a mapping request message) may refer to a control plane message defined by the LISP. The MAP Request message may request for a list of edge devices, for example, xTRs, participating in the same L2VNI. In several more embodiments, the MAP Request message may include an indication of the underlay group mapped to the L2VNI, indicating an intent of the candidate device to become an ETR and receive the BUM traffic for the L2VNI. In numerous embodiments, the process 500 may receive the MAP Request message from the candidate device at the control plane node.

In numerous additional embodiments, the process 500 may transmit, to the candidate device, a list of the existing member devices (block 560). The list may indicate that the existing member devices intend to transmit the BUM traffic. In an example, the list may include an empty list. In another example, the list may include a list of border devices/remote border devices, if traffic steering is enabled. In a further example, the list may include a full list of existing member devices such as xTRs if all the member devices need to receive the network traffic. In further additional embodiments, the process 500 may transmit the list from the control plane node to the candidate device.

Although a specific embodiment for a process 500 for dynamically discovering member devices of an underlay group that intend to transmit BUM traffic to a registered candidate device suitable for carrying out the various steps, processes, methods, and operations described herein is discussed with respect to FIG. 5, any of a variety of systems and/or processes may be utilized in accordance with embodiments of the disclosure. For example, instead of the local control plane database, the control plane node may handover the storage of the list of RLOCs to an external database that is remotely accessible by a WLAN controller in a cloud computing environment. The elements depicted in FIG. 5 may also be interchangeable with other elements of FIGS. 1-4 and FIGS. 6-10 as required to realize a particularly desired embodiment.

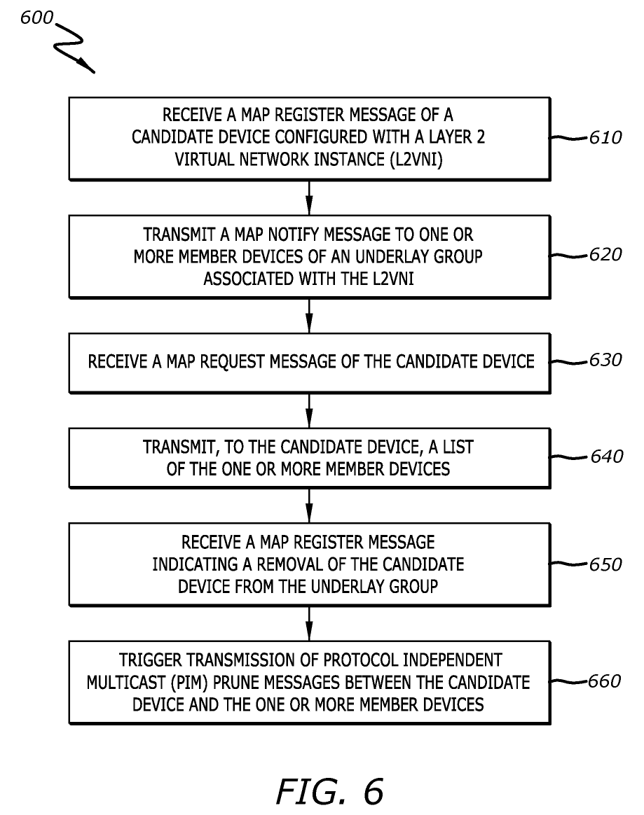

Referring to FIG. 6, a flowchart depicting a process 600 for managing mapping and removal operations with respect to a candidate device configured with a virtual network instance for BUM traffic in accordance with various embodiments of the disclosure is shown. In many embodiments, the process 600 may receive a MAP Register message of a candidate device configured with an L2VNI (block 610). The MAP Register message (e.g., a mapping registration message) may refer to a control plane message defined by the LISP. The MAP Register message may include an RLOC of the candidate device and an indication of an underlay group mapped to the L2VNI for the BUM traffic. The process 600 may support the BUM traffic in an overlay network by utilizing PIM-SSM in an underlay network. In a number of embodiments, the underlay group may be an SSM transport group configured to receive and transmit the BUM traffic. In a variety of embodiments, the MAP Register message may indicate an intent of the candidate device to transmit the BUM traffic for the L2VNI.

The process 600 may receive the MAP Register message from the candidate device configured with the L2VNI. The candidate device may refer to an edge device, for example, a tunnel router such as an ITR, an ETR, or an xTR. The candidate device may be a tunnel router including multiple ports. In various embodiments, one or more of the ports of the candidate device may be configured with a local VLAN that is mapped to the L2VNI. In more embodiments, the L2VNI may be implemented with layer 2 flooding. In additional embodiments, the process 600 may receive the MAP Register message from the candidate device at a control plane node, which may include the map server/map resolver and the control plane database. The control plane database may store the RLOCs of all the edge devices in a LISP-enabled fabric network.

In further embodiments, the process 600 may transmit a MAP Notify message to one or more member devices of the underlay group associated with the L2VNI (block 620). The MAP Notify message (e.g., a mapping notification message) may refer to a control plane message defined by the LISP. In still more embodiments, the process 600 may transmit the MAP Notify message from the control plane node to the member device(s) of the underlay group associated with the L2VNI. The MAP Notify message may notify the member device(s) of the underlay group that the candidate device has joined the L2VNI. In still further embodiments, the MAP Notify message may be configured to trigger transmission of a multicast join message from at least one member device to the candidate device. The multicast join message may, for example, be a PIM join message.

In still additional embodiments, the process 600 may receive a MAP Request message of the candidate device (block 630). The MAP Request message (e.g., a mapping request message) may refer to a control plane message defined by LISP. The MAP Request message may request for a list of edge devices, for example, xTRs, participating in the same L2VNI. In some more embodiments, the MAP Request message may include an indication of the underlay group mapped to the L2VNI, indicating an intent of the candidate device to receive the BUM traffic for the L2VNI. In yet various embodiments, the process 600 may receive the MAP Request message from the candidate device at the control plane node.

In yet more embodiments, the process 600 may transmit, to the candidate device, a list of the one or more member devices (block 640). The list may indicate that the member device(s) intend to transmit the BUM traffic. In an example, the list may include an empty list. In another example, the list may include a list of border devices/remote border devices, if traffic steering is enabled. In a further example, the list may include a full list of member devices such as xTRs if all the member devices need to receive the network traffic. In still yet more embodiments, the process 600 may transmit the list from the control plane node to the candidate device.

In many further embodiments, the process 600 may receive a MAP Register message indicating a removal of the candidate device from the underlay group (block 650). The MAP Register message (e.g., another mapping registration message) may refer to a control plane message defined by the LISP and having a TTL value of zero. The MAP Register message may indicate the removal of the candidate device from the underlay group to discontinue at least one of transmission or reception of the network traffic associated with the L2VNI. The process 600 may receive the MAP Register message (e.g., the another mapping registration message) from the candidate device at the control plane node. In an example, when an xTR no longer wants to transmit or receive the BUM traffic for the L2VNI, the xTR may transmit the MAP Register message to the map server/map resolver of the control plane node to remove itself from the list of xTRs participating in the L2VNI. The map server/map resolver may remove the candidate device from the control plane database and transmit a mapping notification message, for example, a LISP MAP Notify message, to the one or more member devices participating in the L2VNI.

In many additional embodiments, the process 600 may trigger transmission of PIM prune messages between the candidate device and the one or more member devices (block 660). In still yet further embodiments, the PIM prune messages may indicate that the candidate device has transmitted the appropriate MAP Register message to remove itself from a multicast distribution tree for the underlay group. In an example, the candidate device may transmit a PIM prune message to the member device(s) participating in the L2VNI. The member device(s) that received the MAP Notify message from the control plane node may also transmit a PIM prune message to the candidate device leaving the underlay group. In still yet additional embodiments, based on the exchange of the PIM prune messages, the candidate may stop transmitting the BUM traffic to the underlay group and, therefore, cannot deliver the BUM traffic to any connected hosts until the candidate device rejoins the underlay group. In several embodiments, based on the exchange of the PIM prune messages, the candidate may stop receiving the BUM traffic addressed to the underlay group and, therefore, cannot deliver the BUM traffic to any connected hosts until the candidate device rejoins the underlay group. The transmission or reception of the BUM traffic associated with the L2VNI may, therefore, be discontinued.

Although a specific embodiment for a process 600 for managing mapping and removal operations with respect to a candidate device configured with a virtual network instance for BUM traffic suitable for carrying out the various steps, processes, methods, and operations described herein is discussed with respect to FIG. 6, any of a variety of systems and/or processes may be utilized in accordance with embodiments of the disclosure. For example, the process 600 may schedule the transmission of the Map Notify to the member device(s) of the underlay group based on one or more parameters such as map cache state, Time-To-Live (TTL), change events in the control plane database, network load, policy-based triggers, or the like. The elements depicted in FIG. 6 may also be interchangeable with other elements of FIGS. 1-5 and FIGS. 7-10 as required to realize a particularly desired embodiment.

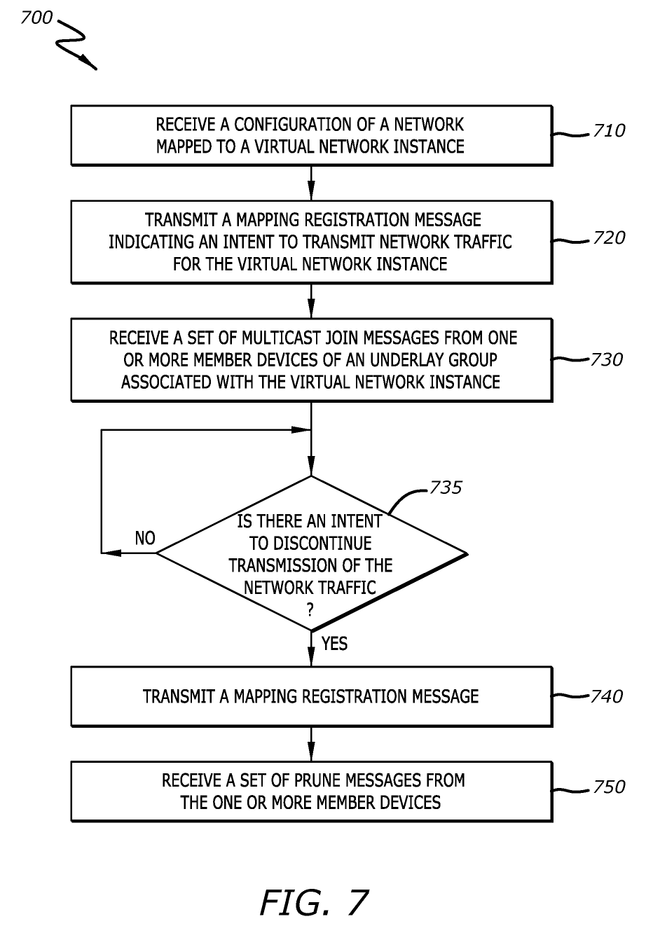

Referring to FIG. 7, a flowchart depicting a process 700 for registering and deregistering a candidate device operating as an ITR with/from an underlay group associated with a virtual network instance for network traffic in accordance with various embodiments of the disclosure is shown. In many embodiments, the process 700 may receive a configuration of a network mapped to a virtual network instance (block 710). For example, a port of the ITR may be configured with a local VLAN that is mapped to an L2VNI with layer 2 flooding enabled. The process 700 may receive the configuration of the local VLAN mapped to the L2VNI. The configuration may include, for example, a VLAN ID, a Virtual Network Identifier (VNI) defining the L2VNI, mapping of the VLAN to the L2VNI, association of the VLAN and the L2VNI with a bridge domain, encapsulation type such as VxLAN, control plane settings, or the like. When the VxLAN network is set up, each VLAN may be associated with a specific L2VNI to allow Layer 2 traffic to be encapsulated and forwarded over a VxLAN fabric. Part of this configuration includes specifying how BUM traffic is handled. In a multicast-enabled VxLAN deployment, each L2VNI may also be associated with a multicast group in the underlay network, which may be used to distribute BUM traffic. The multicast group may be identified by an IP address, for example, an IPv4 address or an IPv6 address. The process 700 may receive the configuration of the network mapped to the virtual network instance at the ITR.

In a number of embodiments, the process 700 may transmit a mapping registration message indicating an intent to transmit network traffic for the virtual network instance (block 720). The mapping registration message may, for example, be a LISP MAP Register message. In a variety of embodiments, the mapping registration message may include an RLOC of the ITR and an indication of the underlay group mapped to the virtual network instance, for example, the L2VNI, for network traffic such as BUM traffic. In various embodiments, the underlay group may be an SSM transport group configured to receive and transmit the BUM traffic, which is supported in an overlay network by utilizing PIM-SSM in an underlay network. In an example, the ITR may transmit the LISP MAP Register message to a control plane node, which may include a map server/map resolver and a control plane database.

In more embodiments, the process 700 may receive a set of multicast join messages from one or more member devices of the underlay group associated with the virtual network instance (block 730). In additional embodiments, the set of multicast join messages may include at least one PIM join message. For example, the set of multicast join messages may include (S,G) PIM join messages where “S” may denote a source host, namely, the ITR, and “G” may denote the underlay group such as the SSM transport group. The member device(s) may, for example, be an xTR. In further embodiments, the xTR(s) may transmit the set of multicast join messages to the ITR upon receiving mapping notification messages that indicate that the ITR has joined the underlay group from the control plane node.

In still more embodiments, the process 700 may determine whether there is an intent to discontinue transmission of the network traffic (block 735). The ITR may no longer wish to transmit the network traffic for the virtual network instance to the member device(s) of the underlay group. In still further embodiments, changes in the control plane database, such as updates indicating that an endpoint device is no longer reachable or has moved to a different network, can prompt the ITR to discontinue transmission of the network traffic to that endpoint device. In still additional embodiments, if the ITR is experiencing high Central Processing Unit (CPU) or memory usage, the ITR may decide to terminate transmission of non-essential network traffic to prioritize critical services or prevent overload. In some more embodiments, in situations of high network congestion, the ITR may wish to throttle or stop transmitting certain types of network traffic to optimally manage bandwidth. In yet various embodiments, detection of persistent errors or packet loss can lead the ITR to cease transmission to prevent further network inefficiencies. In response to determining that there is no intent to discontinue transmission of the network traffic, in still yet further embodiments, the process 700 may iteratively proceed to determine whether there is an intent to discontinue transmission of the network traffic (block 735).

However, in response to determining that there is an intent to discontinue transmission of the network traffic, in yet more embodiments, the process 700 may transmit a mapping registration message (block 740). The mapping registration message may, for example, be a LISP MAP Register message. The mapping registration message may indicate the intent of the ITR to deregister from the underlay group associated with the virtual network instance and discontinue transmission of the network traffic associated with the virtual network instance. The mapping registration message may indicate a removal of the ITR from the underlay group. The process 700 may transmit the mapping registration message to the control plane node. In an example, when the ITR no longer wants to transmit BUM traffic for the L2VNI, the ITR may transmit a LISP MAP Register message to the map server/map resolver of the control plane node to deregister from the underlay group associated with the L2VNI and remove itself from the list of xTRs participating in the L2VNI. The map server/map resolver may remove the ITR from the control plane database and transmit a mapping notification message, for example, a LISP MAP Notify message, to the one or more member devices participating in the L2VNI.

In still yet more embodiments, the process 700 may receive a set of prune messages from the one or more member devices (block 750). The set of prune messages may, for example, be PIM prune messages. In many further embodiments, the PIM prune messages may indicate that the ITR has transmitted the appropriate mapping registration message to remove itself from the underlay group associated with the virtual network instance. The member device(s) may, for example, be the xTR(s), participating in the virtual network instance and that received the mapping notification message from the control plane node. Based on the exchange of the PIM prune messages, the ITR may stop transmitting the network traffic addressed to the underlay group. The transmission of the network traffic associated with the L2VNI may, therefore, be discontinued.

Although a specific embodiment for a process 700 for registering and deregistering a candidate device operating as an ITR with/from an underlay group associated with a virtual network instance for network traffic suitable for carrying out the various steps, processes, methods, and operations described herein is discussed with respect to FIG. 7, any of a variety of systems and/or processes may be utilized in accordance with embodiments of the disclosure. For example, on detecting potential security threats or malicious traffic in a LISP-enabled fabric network, the process 700 may prompt the ITR to block or discontinue transmission of certain data flows to protect the LISP-enabled fabric network. The elements depicted in FIG. 7 may also be interchangeable with other elements of FIGS. 1-6 and FIGS. 8-10 as required to realize a particularly desired embodiment.

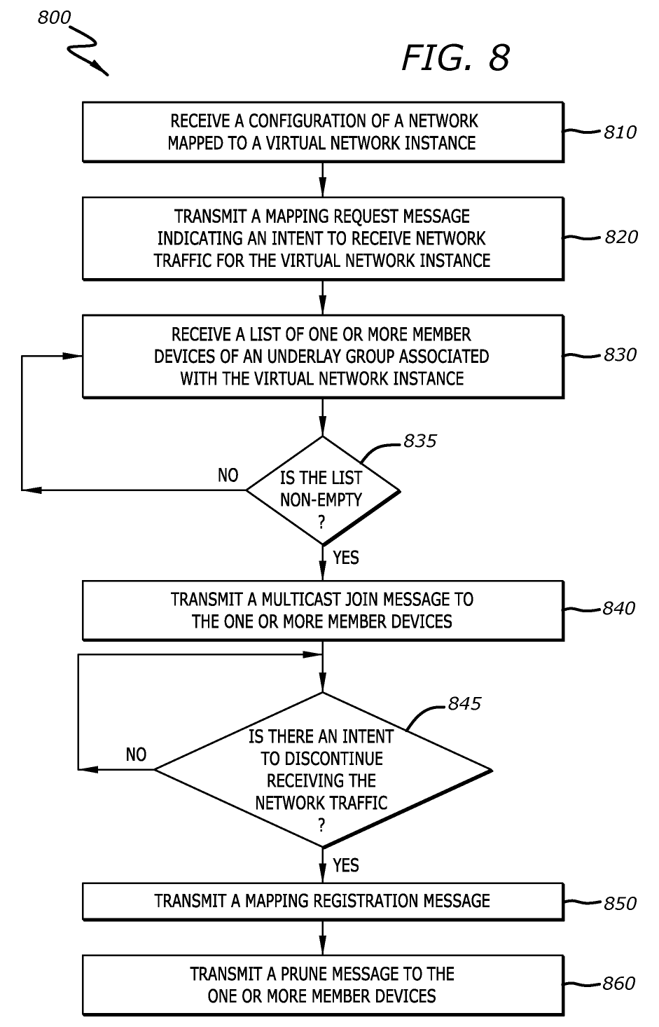

Referring to FIG. 8, a flowchart depicting a process 800 for registering and deregistering a candidate device operating as an ETR with/from an underlay group associated with a virtual network instance for network traffic in accordance with various embodiments of the disclosure is shown. In many embodiments, the process 800 may receive a configuration of a network mapped to a virtual network instance (block 810). For example, a port of the ETR may be configured with a local VLAN that is mapped to an L2VNI with layer 2 flooding enabled. The process 800 may receive the configuration of the local VLAN mapped to the L2VNI. The configuration may include, for example, a VLAN ID, a VNI defining the L2VNI, mapping of the VLAN to the L2VNI, association of the VLAN and the L2VNI with a bridge domain, encapsulation type such as VxLAN, control plane settings, or the like. The process 800 may receive the configuration of the network mapped to the virtual network instance at the ETR.

In a number of embodiments, the process 800 may transmit a mapping request message indicating an intent to receive network traffic for the virtual network instance (block 820). In a variety of embodiments, the mapping request message may register the intent to receive the network traffic for the virtual network instance. The mapping request message may, for example, be a LISP MAP Request message. The mapping request message may request for a list of edge devices, for example, xTRs, participating in the same virtual network instance. The process 800 may transmit the mapping request message from the ETR to a control plane node, which may include a map server/map resolver and a control plane database. In one or more embodiments, the mapping request message may include an RLOC of the ETR and an indication of the underlay group mapped to the virtual network instance, for example, the L2VNI, for network traffic such as BUM traffic.

In various embodiments, the process 800 may receive a list of one or more member devices of the underlay group associated with the virtual network instance (block 830). The list may indicate that the member device(s) intends to transmit the network traffic to the ETR. In an example, the list may include an empty list. In another example, the list may include a list of border devices/remote border devices, if traffic steering is enabled. In a further example, the list may include a full list of member devices such as xTRs intending to transmit the network traffic. In more embodiments, the list may be stored in the control plane database of the control plane node. In additional embodiments, the process 800 may receive the list from the control plane node.

In further embodiments, the process 800 may determine whether the list is non-empty (block 835). For example, the process 800 may determine whether the list includes a list of border devices/remote border devices, if traffic steering is enabled. In another example, the process 800 may determine whether the list includes a full list of edge devices such as xTRs intending to transmit the network traffic. In still more embodiments, the process 800 may determine a length or a size of the list. If the length or the size of the list is greater than zero, the process 800 may consider the list as non-empty. In still further embodiments, the process 800 may determine whether the list is null or has no elements. If the list is not null and contains one or more elements, the process 800 may consider the list as non-empty.

In response to determining that the list is empty, in yet various embodiments, the process 800 may proceed to receive a list of one or more member devices of the underlay group associated with the virtual network instance (block 830). In yet more embodiments, the process 800 may iteratively request the control plane node to transmit the list of member devices of the underlay group associated with the virtual network instance. The process 800 may further iteratively determine whether the list is non-empty, for example, by determining a length or a size of the list, determining whether the list is null or has no elements, or the like.

However, in response to determining that the list is non-empty, in still additional embodiments, the process 800 may transmit a multicast join message to the one or more member devices (block 840). The multicast join message may, for example, be a PIM-SSM join message. The PIM-SSM join message may include, for example, the address of the underlay group associated with the virtual network instance and the specific address of the member device(s) from which the ETR wants to receive the network traffic. In some more embodiments, the non-empty list may include the RLOC(s) of the member device(s). The process 800 may transmit the multicast join message from the ETR to the member device(s) based on the RLOC(s) of the member device(s).

In still yet more embodiments, the process 800 may determine whether there is an intent to discontinue receiving the network traffic (block 845). The ETR may no longer wish to receive the network traffic for the virtual network instance from the member device(s) of the underlay group. In many further embodiments, changes in the control plane database, such as updates indicating that an endpoint device is no longer reachable or has moved to a different network, can prompt the ETR to discontinue receiving the network traffic from that endpoint device. In many additional embodiments, if a session between the ETR and the member device(s) is terminated, either by user action or application-level signaling, the ETR may intend to cease reception of the network traffic related to that session. In still yet further embodiments, if the ETR is experiencing high CPU or memory usage, the ETR may decide to terminate reception of non-critical network traffic to prioritize critical services or prevent overload. In still yet additional embodiments, in situations of high network congestion, the ETR may wish to throttle or terminate reception of certain types of network traffic to optimally manage bandwidth. In several embodiments, detection of persistent errors or packet loss can lead the ETR to cease reception of the network traffic to prevent further network inefficiencies. In response to determining that there is no intent to discontinue receiving the network traffic, in many embodiments, the process 800 may continue determining whether there is an intent to discontinue receiving the network traffic (block 845).

In response to determining that there is an intent to discontinue receiving the network traffic, in several more embodiments, the process 800 may transmit a mapping registration message (block 850). The mapping registration message may, for example, be a LISP MAP Register message. The mapping registration message may indicate intent of the ETR to deregister from the underlay group associated with the virtual network instance and discontinue reception of the network traffic associated with the virtual network instance. The process 800 may transmit the mapping registration message to the control plane node. In an example, when the ETR no longer wants to receive BUM traffic for the L2VNI, the ETR may transmit a LISP MAP Register message to the map server/map resolver of the control plane node to deregister from the underlay group associated with the L2VNI and remove itself from the list of xTRs participating in the L2VNI. The map server/map resolver may remove the ETR from the control plane database and transmit a mapping notification message, for example, a LISP MAP Notify message, to the one or more member devices participating in the L2VNI.

In numerous embodiments, the process 800 may transmit a prune message to the one or more member devices (block 860). The prune message may, for example, be a PIM prune message. In numerous additional embodiments, the PIM prune message may indicate that the ETR has transmitted the appropriate mapping registration message to remove itself from the underlay group associated with the virtual network instance. The member device(s) may, for example, be the xTR(s), participating in the virtual network instance and that received a mapping notification message from the control plane node. The mapping notification message received by the member device(s) from the control plane node may indicate that the ETR has deregistered from the underlay group. In further additional embodiments, the member device(s) participating in the virtual network instance may also transmit the PIM prune message to the ETR. Based on the exchange of the PIM prune messages, the ETR may stop receiving the network traffic from the member device(s) in the underlay group. The reception of the network traffic associated with the L2VNI may, therefore, be discontinued. In one or more embodiments, in response to determining that there is an intent to discontinue receiving the network traffic, the process 800 may directly transmit the prune message to the one or more member devices, without transmitting the mapping registration message to the control plane node and without the control plane node having to notify the member device(s) about the deregistration of the ETR from the underlay group.

Although a specific embodiment for a process 800 for registering and deregistering a candidate device operating as an ETR with/from an underlay group associated with a virtual network instance for network traffic suitable for carrying out the various steps, processes, methods, and operations described herein is discussed with respect to FIG. 8, any of a variety of systems and/or processes may be utilized in accordance with embodiments of the disclosure. For example, to identify a non-empty list, the process 800 may iterate through the list to determine at least one valid entry, and if an entry is found, the process 800 may confirm that the list is non-empty. In another example, identify a non-empty list, the process 800 may check for metadata or flags indicating whether the list has entries. The elements depicted in FIG. 8 may also be interchangeable with other elements of FIGS. 1-7 and FIGS. 9-10 as required to realize a particularly desired embodiment.

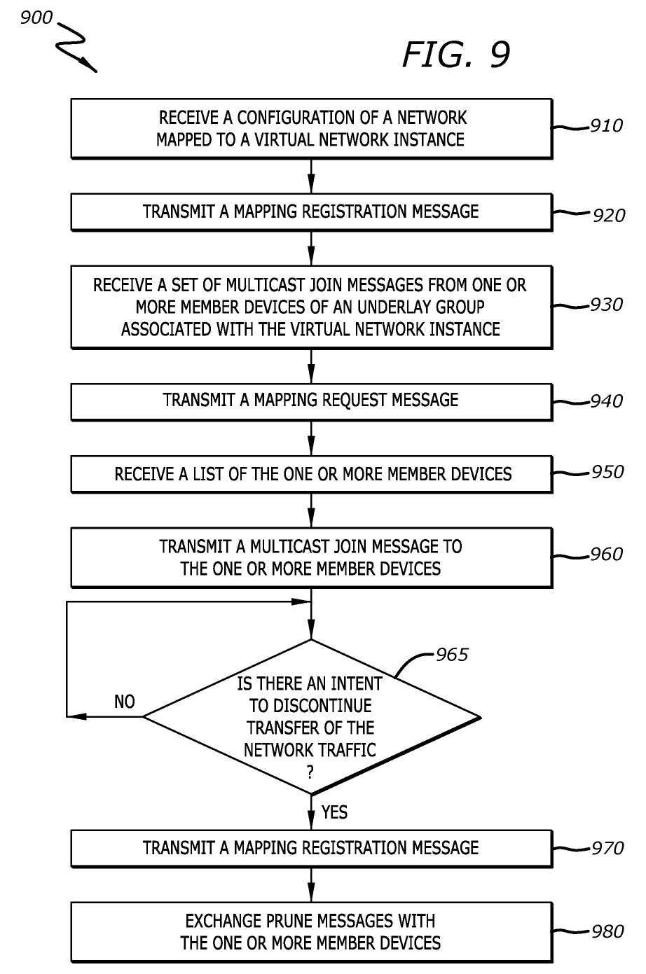

Referring to FIG. 9, a flowchart depicting a process 900 for registering and deregistering a candidate device operating as an ingress/egress tunnel router (xTR) with/from an underlay group associated with a virtual network instance for network traffic in accordance with various embodiments of the disclosure is shown. In many embodiments, the process 900 may receive a configuration of a network mapped to a virtual network instance (block 910). For example, a port of the xTR may be configured with a local VLAN that is mapped to an L2VNI with layer 2 flooding enabled. The process 900 may receive the configuration of the local VLAN mapped to the L2VNI. The configuration may include, for example, a VLAN ID, a VNI defining the L2VNI, mapping of the VLAN to the L2VNI, association of the VLAN and the L2VNI with a bridge domain, encapsulation type such as VxLAN, control plane settings, or the like. The process 900 may receive the configuration of the network mapped to the virtual network instance at the xTR.

In a number of embodiments, the process 900 may transmit a mapping registration message (block 920). The mapping registration message may, for example, be a LISP MAP Register message. In a variety of embodiments, the mapping registration message may indicate an intent to transmit the network traffic for the virtual network instance. In various embodiments, the mapping registration message may include an RLOC of the xTR and an indication of an underlay group mapped to the virtual network instance, for example, the L2VNI, for network traffic such as BUM traffic. In more embodiments, the underlay group may be an SSM transport group configured to receive and transmit the BUM traffic, which is supported in an overlay network by utilizing PIM-SSM in an underlay network. In an example, the xTR may transmit the LISP MAP Register message to a control plane node, which may include a map server/map resolver and a control plane database.

In additional embodiments, the process 900 may receive a set of multicast join messages from one or more member devices of the underlay group associated with the virtual network instance (block 930). In further embodiments, the set of multicast join messages may be (S,G) PIM join messages where “S” may denote a source host, namely, the xTR, and “G” may denote the underlay group, for example, the SSM transport group. The member device(s) may, for example, be a member xTR. In still more embodiments, the member xTR(s) may transmit the set of multicast join messages to the candidate xTR upon receiving mapping notification messages that indicate that the candidate xTR has joined the underlay group from the control plane node.

In still further embodiments, the process 900 may transmit a mapping request message (block 940). The mapping request message may, for example, be a LISP MAP Request message. In still additional embodiments, the mapping request message may indicate an intent to receive network traffic for the virtual network instance. The mapping request message may request for a list of edge devices, for example, the member xTRs, participating in the same virtual network instance. The process 900 may transmit the mapping request message from the xTR to the control plane node.

In some more embodiments, the process 900 may receive a list of the one or more member devices (block 950). The list may indicate that the member device(s) intends to transmit the network traffic to the xTR. In an example, the list may include an empty list. In another example, the list may include a list of border devices/remote border devices, if traffic steering is enabled. In a further example, the list may include a full list of edge devices such as member xTRs intending to transmit the network traffic. In yet various embodiments, the list may be stored in the control plane database of the control plane node. In yet more embodiments, the process 900 may receive the list from the control plane node.

In still yet more embodiments, the process 900 may transmit a multicast join message to the one or more member devices (block 960). The multicast join message may, for example, be a PIM-SSM join message. The PIM-SSM join message may include, for example, the address of the underlay group associated with the virtual network instance and the specific address of the member device(s) from which the xTR wants to receive the network traffic. In many further embodiments, the non-empty list may include the RLOC(s) of the member device(s). The process 900 may transmit the multicast join message from the xTR to the member device(s) based on the RLOC(s) of the member device(s).

In many additional embodiments, the process 900 may determine whether there is an intent to discontinue transfer of the network traffic (block 965). The candidate xTR may no longer wish to transmit or receive the network traffic for the virtual network instance to or from the member device(s) of the underlay group. In still yet further embodiments, changes in the control plane database, such as updates indicating that an endpoint device is no longer reachable or has moved to a different network, can prompt the candidate xTR to discontinue transmission or reception of the network traffic to or from that endpoint device. In still yet additional embodiments, if the candidate xTR is experiencing high CPU or memory usage, the candidate xTR may decide to terminate transmission or reception of non-critical network traffic to prioritize critical services or prevent overload. In several embodiments, in situations of high network congestion, the candidate xTR may wish to throttle or terminate transmission or reception of certain types of network traffic to optimally manage bandwidth. In several more embodiments, detection of persistent errors or packet loss can lead the candidate xTR to cease transmission or reception of the network traffic to prevent further network inefficiencies.

In response to determining that there is an intent to discontinue transfer of the network traffic, in numerous embodiments, the process 900 may transmit a mapping registration message (block 970). The mapping registration message may, for example, be a LISP MAP Register message with a TTL value of zero. The mapping registration message may indicate intent of the candidate xTR to deregister from the underlay group associated with the virtual network instance and discontinue transmission or reception of the network traffic associated with the virtual network instance. The process 900 may transmit the mapping registration message to the control plane node. In an example, when the candidate xTR no longer wants to transmit or receive BUM traffic for the L2VNI, the candidate xTR may transmit a LISP MAP Register message to the map server/map resolver of the control plane node to deregister from the underlay group associated with the L2VNI and remove itself from the list of xTRs participating in the L2VNI. The map server/map resolver may remove the candidate xTR from the control plane database and transmit a mapping notification message, for example, a LISP MAP Notify message, to the one or more member devices participating in the L2VNI.

In numerous additional embodiments, the process 900 may exchange prune messages with the one or more member devices (block 980). The prune messages may, for example, be PIM prune messages. In further additional embodiments, the PIM prune messages may indicate that the candidate xTR has transmitted the appropriate mapping registration message to remove itself from the underlay group associated with the virtual network instance. The member device(s) may, for example, be the member xTR(s), participating in the virtual network instance and that received the mapping notification message from the control plane node. In many embodiments, the candidate xTR may transmit a PIM prune message to the member device(s) participating in the virtual network instance, and the member xTR(s) may transmit a PIM prune message to the candidate xTR participating in the virtual network instance. Based on the exchange of the PIM prune messages, the candidate xTR may stop transmitting or receiving the network traffic to or from the underlay group. The transmission or the reception of the network traffic associated with the L2VNI may, therefore, be discontinued.

However, in response to determining that there is no intent to discontinue transfer of the network traffic, in a number of embodiments, the process 900 may iteratively proceed to determine whether there is an intent to discontinue transfer of the network traffic (block 965). In a variety of embodiments, the process 900 may detect changes in the control plane database, such as updates indicating that an endpoint device is no longer reachable or has moved to a different network, which may prompt the candidate xTR to discontinue transmission or reception of the network traffic to or from that endpoint device. In various embodiments, the process 900 may determine whether the candidate xTR is experiencing high CPU or memory usage and prompt the candidate xTR to terminate transmission or reception of non-essential network traffic to prioritize critical services or prevent overload. In more embodiments, in situations of high network congestion, the process 900 may prompt the candidate xTR to throttle or stop transmitting or receiving certain types of network traffic to optimally manage bandwidth. In additional embodiments, the process 900 may detect persistent errors or packet loss and prompt the candidate xTR to cease transmission or reception of the network traffic to prevent further network inefficiencies.

Although a specific embodiment for a process 900 for registering and deregistering a candidate device operating as an ingress/egress tunnel router with/from an underlay group associated with a virtual network instance for network traffic suitable for carrying out the various steps, processes, methods, and operations described herein is discussed with respect to FIG. 9, any of a variety of systems and/or processes may be utilized in accordance with embodiments of the disclosure. For example, in response to the mapping request message, the process 900 may receive the list of the member device(s) based on a schedule determined by the control plane node, where the control plane mode may transmit the list based on one or more parameters such as map cache state, Time-To-Live (TTL), change events in the control plane database, network load, policy-based triggers, or the like. The elements depicted in FIG. 9 may also be interchangeable with other elements of FIGS. 1-8 and FIG. 10 as required to realize a particularly desired embodiment.

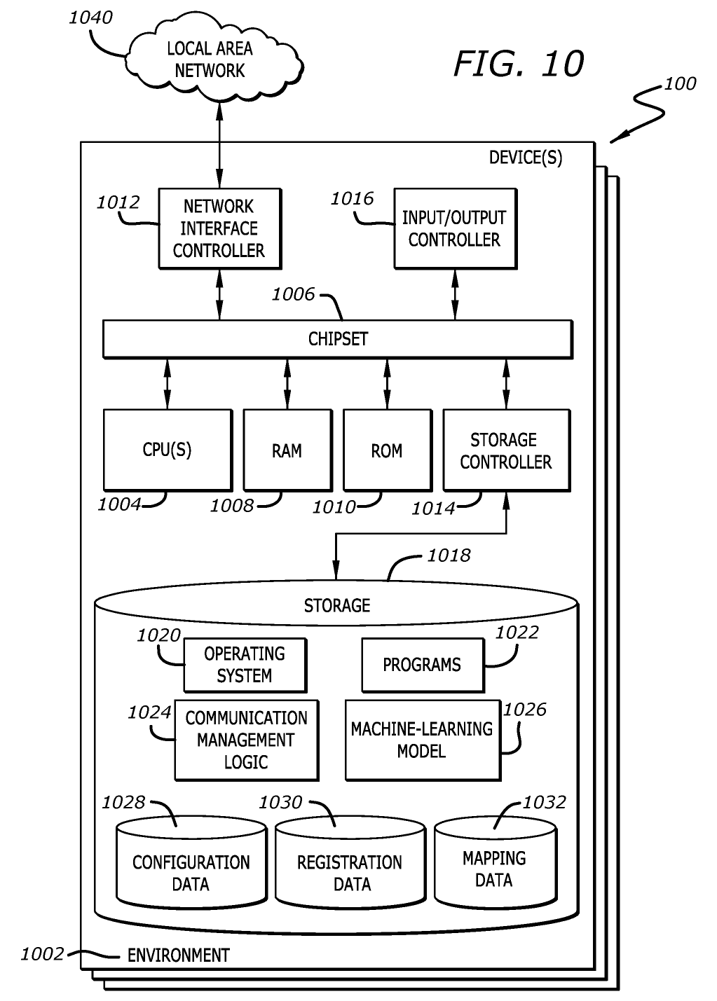

Referring to FIG. 10, a conceptual block diagram of a device 1000 capable of executing components and a communication management logic 1024 for implementing the functionality and embodiments described above is shown. The embodiment of the conceptual block diagram depicted in FIG. 10 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 1000 may, in some examples, correspond to a physical device or to a virtual resource described herein. The device 1000 can be a network device (for example, an ITR, an ETR, an xTR, a control plane node, or a WLAN controller), an endpoint device, or the like in accordance with various embodiments of the disclosure.

In many embodiments, the device 1000 may include an environment 1002 such as a baseboard or a “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In a number of embodiments, one or more processors 1004, such as, but not limited to, central processing units (CPUs) can be configured to operate in conjunction with a chipset 1006. The processor(s) 1004 can be standard programmable CPUs that perform arithmetic and logical operations necessary for the operation of the device 1000.

In a variety of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (RAM) 1008, which can be utilized as the main memory in the device 1000 in some embodiments. The chipset 1006 can further be configured to provide an interface to a computer-readable storage medium such as a read-only memory (ROM) 1010 or a Non-Volatile RAM (NVRAM) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface controller (NIC) 1012, which may include a gigabit Ethernet adapter or similar component. The NIC 1012 can be capable of connecting the device 1000 to other devices over the network 1040. It is contemplated that multiple NICs 1012 may be present in the device 1000, connecting the device 1000 to other types of networks and remote systems.

In more embodiments, the device 1000 can be connected to a storage 1018 that provides non-volatile storage for data accessible by the device 1000. The storage 1018 can, for example, store an operating system 1020, applications or programs 1022, configuration data 1028, registration data 1030, and mapping data 1032, which are described in greater detail below. The storage 1018 can be connected to the environment 1002 through a storage controller 1014 connected to the chipset 1006. In additional embodiments, the storage 1018 can include one or more physical storage units. The storage controller 1014 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology utilized to implement the physical storage units, whether the storage 1018 is characterized as primary or secondary storage, and the like. For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to the device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable programmable ROM (EPROM), Electrically-Erasable programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1018 can store an operating system 1020 utilized to control the operation of the device 1000. According to one embodiment, the operating system 1020 includes the LINUX operating system. According to another embodiment, the operating system 1020 includes the WINDOWS® SERVER operating system from MICROSOFT Corporation of Redmond, Washington. According to further embodiments, the operating system 1020 can include the UNIX operating system or one of its variants. It should be appreciated that other operating systems can also be utilized. The storage 1018 can store other system or application programs and data utilized by the device 1000.

In still more embodiments, the storage 1018 or other computer-readable storage media is encoded with computer-executable instructions which, when loaded into the device 1000, may transform the device 1000 from a general-purpose computing system into a special-purpose computer capable of implementing the embodiments described herein. These computer-executable instructions may be stored as applications or programs 1022 and transform the device 1000 by specifying how the processor(s) 1004 can transition between states, as described above. In still further embodiments, the device 1000 has access to computer-readable storage media storing computer-executable instructions which, when executed by the device 1000, perform the various processes described above with regard to FIGS. 1-10. In still additional embodiments, the device 1000 can also include computer-readable storage media having instructions stored thereupon for performing any of the other computer-implemented operations described herein.

In some more embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 may not include all of the components shown in FIG. 10, and can include other components that are not explicitly shown in FIG. 10, or may utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In yet various embodiments, the device 1000 can include a communication management logic 1024 that may be responsible for supporting network traffic, for example, BUM traffic, in an overlay network by utilizing PIM-SSM in an underlay network, while improving configurations and removing dependency on PIM-ASM. In yet more embodiments, the communication management logic may operate in the control plane node. In embodiments where the device 1000 corresponds to the control plane node, the communication management logic 1024 can be configured to perform various operations such as, but not limited to, receiving at least one of a mapping registration message or a mapping request message of a candidate device configured with a virtual network instance; in response to receiving the mapping registration message, transmitting a mapping notification message to one or more member devices of an underlay group associated with the virtual network instance, where the mapping notification message may indicate that the candidate device has joined the underlay group; and in response to receiving the mapping request message, transmitting a list to the candidate device indicating that the member device(s) intends to transmit network traffic. In embodiments where the device 1000 corresponds to a network device, for example, an ITR, the communication management logic 1024 can be configured to perform various operations such as, but not limited to, receiving a configuration of a network mapped to a virtual network instance; transmitting a mapping registration message indicating an intent to transmit network traffic for the virtual network instance; and receiving, based on transmitting the mapping registration message, a set of multicast join messages from the member device(s) of an underlay group associated with the virtual network instance. In embodiments where the device 1000 corresponds to a network device, for example, an ETR, the communication management logic 1024 can be configured to perform various operations such as, but not limited to, receiving a configuration of a network mapped to a virtual network instance; transmitting a mapping request message indicating an intent to receive network traffic for the virtual network instance; receiving a list of one or more member devices of an underlay group associated with the virtual network instance; and transmitting a multicast join message to the member device(s) based on the received list.

Those skilled in the art will recognize that the communication management logic 1024 can include various hardware and/or software deployments and can be configured in a variety of ways. In still yet more embodiments, the communication management logic 1024 can be configured as a standalone device, exist as a logic in another network device, be distributed among various network devices operating in tandem, or remotely operated as part of a cloud-based network management tool. In many further embodiments, one or more servers can be configured with the communication management logic 1024 or can otherwise operate as the communication management logic 1024. In many additional embodiments, the communication management logic 1024 may operate on one or more servers connected to a communication network, for example, the Internet. The communication network can include wired networks or wireless networks. The communication management logic 1024 can be provided as a cloud-based service that can service remote networks, such as, but not limited to a deployed network. Further, in still yet further embodiments, the communication management logic 1024 may be operated as a distributed logic across multiple network devices. In an embodiment, the control plane node can operate as the communication management logic 1024 or may have multiple devices operate as the communication management logic 1024 in a distributed manner.

In still yet additional embodiments, the device 1000 may correspond to a network device such as a WLAN controller. In such embodiments, the communication management logic 1024 can be configured to perform various operations such as, but not limited to, registering MAC addresses of the endpoint devices into the control plane database during multicast register/join operations; supplying edge device RLOC-association updates to the control plane database 116 during roam events; managing EID-to-RLOC mapping information from the map server of the control plane node; and handling conventional tasks associated with a WLAN controller as well as interactions with the fabric control plane for multicast registration/join operations.

In several embodiments, the storage 1018 can include configuration data 1028. The configuration data 1028 may relate to data representative of a configuration of a virtual network, for example, a VLAN, that is mapped to an L2VNI with layer 2 flooding enabled. For example, the configuration data 1028 may include a VLAN ID, a Virtual Network Identifier (VNI) defining the L2VNI, mapping of the VLAN to the L2VNI, mapping of the L2VNI for a particular VLAN to a specific multicast group address, association of the VLAN and the L2VNI with a bridge domain, encapsulation type such as Virtual eXtensible LAN (VxLAN), control plane settings, or the like. The configuration data 1028 may be utilized by the communication management logic 1024 to configure the port of a candidate device, for example an ITR, ETR, or xTR, with a local VLAN that is mapped to an L2VNI with layer 2 flooding enabled.

In several more embodiments, the storage 1018 can include registration data 1030. The registration data 1030 may relate to data representative of registering intent to transmit network traffic, for example, BUM traffic, for a specific underlay group such as a multicast group in the underlay. The registration data 1030 can include, but is not limited to, RLOC of the candidate device intending to transmit the network traffic for the specific underlay group. The registration data 1030 can also include, but is not limited to, the underlay group that has been mapped to a particular virtual network instance, for example, the L2VNI, for the network traffic. The registration data 1030 may be utilized by the communication management logic 1024 to register the intent of the candidate device to transmit the network traffic for the specific underlay group associated with the virtual network instance.

In numerous embodiments, the storage 1018 can include mapping data 1032. The mapping data 1032 may relate to data representative of the request for the underlay group that has been mapped to a virtual network instance for the network traffic. For example, the mapping data 1032 may include a list of xTRs participating in the same virtual network instance, indicating intent for the candidate device to receive the network traffic for the virtual network instance.

In numerous additional embodiments, data may be processed into a format usable by a machine-learning (“ML”) model 1026 (e.g., feature vectors), and or other pre-processing techniques. The ML model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models. The ML model 1026 may be configured to analyze the configuration data 1028, the registration data 1030, and the mapping data 1032 for supporting network traffic, for example, BUM traffic, in an overlay network by utilizing PIM-SSM in an underlay network, while improving configurations and removing dependency on PIM-ASM. In further additional embodiments, the ML model 1026 may be utilized to identify various parameters to include in the registration data 1030 and the mapping data 1032. For example, the ML model 1026 may analyze the registration data 1030 and the mapping data 1032 and identify parameters that are required to augment the registration data 1030 and the mapping data 1032. Once the parameters are identified, the communication management logic 1024 may utilize the parameters to support the network traffic, for example, the BUM traffic, in the overlay network by utilizing PIM-SSM in the underlay network, while improving configurations and removing dependency on PIM-ASM. For example, the ML model 1026 may be configured to receive an optimal layer 2 flooding strategy based on real-time network conditions. The communication management logic 1024 may then utilize trained models to predict the scope of layer 2 flooding based on current conditions and anticipated changes, optimizing BUM traffic support dynamically. In another example, the ML model 1026 may be configured to determine intent to receive and send the BUM traffic for a specific underlay group.

Although a specific embodiment for a device 1000 capable of executing components and the communication management logic 1024 for implementing the functionality and embodiments suitable for carrying out the various steps, processes, methods, and operations described herein is discussed with respect to FIG. 10, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the communication management logic 1024 acts in tandem between the devices. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A system, comprising:
a processor;
a network interface controller configured to provide access to a network; and
a memory communicatively coupled to the processor, wherein the memory comprises a communication management logic that is configured to:
receive at least one of a mapping registration message or a mapping request message of a candidate device configured with a virtual network instance;
in response to receiving the mapping registration message, transmit a mapping notification message to one or more member devices of an underlay group associated with the virtual network instance, the mapping notification message indicating that the candidate device has joined the underlay group; and
in response to receiving the mapping request message, transmit, to the candidate device, a list indicating that the one or more member devices intend to transmit network traffic.

2. The system of claim 1, further comprising a control plane database configured to update a list of routing locators with a routing locator of the candidate device that joined the underlay group.

3. The system of claim 1, wherein the underlay group is a source-specific multicast transport group configured to receive and transmit the network traffic.

4. The system of claim 1, wherein the mapping registration message, the mapping request message, and the mapping notification message are control plane messages defined by a locator/identifier separation protocol.

5. The system of claim 1, wherein the mapping registration message comprises a routing locator of the candidate device and an indication of the underlay group mapped to the virtual network instance, indicating an intent of the candidate device to transmit the network traffic for the virtual network instance.

6. The system of claim 1, wherein the mapping request message comprises an indication of the underlay group mapped to the virtual network instance, indicating an intent of the candidate device to receive the network traffic for the virtual network instance.

7. The system of claim 1, wherein the candidate device is a tunnel router comprising a plurality of ports.

8. The system of claim 7, wherein one or more ports of the plurality of ports are configured with a virtual local area network mapped to the virtual network instance.

9. The system of claim 1, wherein the virtual network instance corresponds to a layer 2 virtual network instance implemented with layer 2 flooding.

10. The system of claim 1, wherein the mapping notification message is configured to trigger transmission of a multicast join message from at least one member device of the one or more member devices to the candidate device.

11. The system of claim 1, wherein the communication management logic is further configured to receive another mapping registration message from the candidate device, the another mapping registration message indicating a removal of the candidate device from the underlay group to discontinue at least one of transmission or reception of the network traffic associated with the virtual network instance.

12. The system of claim 1, wherein the network traffic comprises broadcast, unknown unicast, or link-local multicast traffic that is supported in an overlay network by utilizing protocol independent multicast-source-specific multicast in an underlay network.

13. A network device, comprising:
a processor;
a network interface controller configured to provide access to a network; and
a memory communicatively coupled to the processor, wherein the memory comprises a communication management logic that is configured to:
receive a configuration of a network mapped to a virtual network instance;
transmit a mapping registration message indicating an intent to transmit network traffic for the virtual network instance; and
receive, based on transmitting the mapping registration message, a set of multicast join messages from one or more member devices of an underlay group associated with the virtual network instance.

14. The network device of claim 13, wherein the set of multicast join messages comprises at least one protocol independent multicast join message.

15. The network device of claim 13, wherein the communication management logic is further configured to:
transmit another mapping registration message to a locator/identifier separation protocol control plane, indicating a removal of the network device from the underlay group; and
receive, based on transmitting the another mapping registration message, a set of prune messages from the one or more member devices.

16. A network device, comprising:
a processor;
a network interface controller configured to provide access to a network; and
a memory communicatively coupled to the processor, wherein the memory comprises a communication management logic that is configured to:
receive a configuration of a network mapped to a virtual network instance;
transmit a mapping request message indicating an intent to receive network traffic for the virtual network instance;
receive a list of one or more member devices of an underlay group associated with the virtual network instance; and
transmit a multicast join message to the one or more member devices based on the received list.

17. The network device of claim 16, wherein the list is a full list of the one or more member devices that intend to transmit the network traffic.

18. The network device of claim 16, wherein the multicast join message is transmitted to the one or more member devices in the underlay group in response to the list being a non-empty list.

19. The network device of claim 16, wherein the multicast join message is a protocol independent multicast-source-specific multicast message.

20. The network device of claim 16, wherein the communication management logic is further configured to transmit at least one of a mapping registration message to a locator/identifier separation protocol control plane or a prune message to the one or more member devices, indicating a removal of the network device from the underlay group.
